(19) United States
(12) Patent Application Publication
(10) Pub. No.: US 2026/0049815 A1
(43) Pub. Date: Feb. 19, 2026

(54) INERTIAL POSE TRACKING USING POSE FILTERING WITH LEARNED ORIENTATION CHANGE MEASUREMENT

(71) Applicant: QUALCOMM Incorporated, San Diego, CA (US)

(72) Inventors: Diyan TENG, Sunnyvale, CA (US); Nisarg Keyurbhai TRIVEDI, Santa Clara, CA (US); Junsheng HAN, Los Altos Hills, CA (US); Victor KULIK, San Jose, CA (US); Rashmi KULKARNI, Redwood City, CA (US)

(21) Appl. No.: 18/747,372

(22) Filed: Jun. 18, 2024

(51) Int. Cl. G01C 9/00

(52) U.S. Cl. CPC G01C 9/00

(57) ABSTRACT

Systems and techniques are provided for determining a pose. A process can include obtaining inertial measurement unit (IMU) data from an IMU associated with a device. The IMU data can be used to determine a propagated state associated with a state estimation engine, wherein the propagated state includes an initial orientation estimate corresponding to a pose of the device. The state estimation engine can comprise an Extended Kalman Filter (EKF). A predicted orientation measurement can be generated using a first machine learning network to process the IMU data and the initial orientation estimate included in the propagated state associated with the state estimation engine. An updated state associated with the state estimation engine can be determined based on using the predicted orientation measurement to update the propagated state. A device pose estimate can be determined based on the updated state associated with the state estimation engine.

### FIELD

The present disclosure generally relates to pose tracking using inertial measurement information.

### BACKGROUND

Pose estimation can be used in various applications, such as computer vision and extended reality (XR) (e.g., including augmented reality (AR) and virtual reality (VR), or combinations thereof, mixed reality (MR)), to determine the position and orientation of a human or object relative to a scene or environment. The pose information can be used to manage interactions between a human or object and a specific scene or environment. For example, the pose (e.g., position and orientation) of a robot can be used to allow the robot to manipulate an object or avoid colliding with an object when moving about a scene. As another example, the pose of a user or a device worn by the user can be used to enhance or augment the user's real or physical environment with virtual content.

Pose information can be estimated using six degrees of freedom (6DOF) to represent the position and orientation of an object in three-dimensional (3D) space. For example, 6DOF pose information can include three translational components representing the position of the object (e.g., x, y, z) and can include three rotational components representing the orientation of the object (e.g., roll or the rotation around the x-axis, pitch or the rotation around the y-axis, and yaw or the rotation around the z-axis). In some examples, 6DOF pose tracking can be performed to estimate 6DOF pose information over time, as a user or object changes position and/or orientation within a 3D space 6DOF pose tracking may be performed based on estimates of translational and rotational motion that are determined using an inertial measurement unit (IMU)

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for predicting pose information. According to at least one illustrative example, a method of predicting pose information is provided, the method including: obtaining inertial measurement unit (IMU) data from an IMU associated with a device; determining, using the IMU data, a propagated state associated with an Extended Kalman Filter (EKF), wherein the propagated state includes an initial orientation estimate corresponding to a pose of the device; generating a predicted orientation measurement based on using a first machine learning network to process the IMU data and the initial orientation estimate included in the propagated state associated with the EKF; determining an updated state associated with the EKF, wherein the updated state is determined based on using the predicted orientation measurement to update the propagated state; and determining a device pose estimate based on the updated state associated with the EKF.

In another illustrative example, an apparatus for predicting pose information is provided. The apparatus includes at least one memory and at least one processor coupled to the at least one memory and configured to: obtain inertial measurement unit (IMU) data from an IMU associated with a device; determine, using the IMU data, a propagated state associated with an Extended Kalman Filter (EKF), wherein the propagated state includes an initial orientation estimate corresponding to a pose of the device; generate a predicted orientation measurement based on using a first machine learning network to process the IMU data and the initial orientation estimate included in the propagated state associated with the EKF; determine an updated state associated with the EKF, wherein the updated state is determined based on using the predicted orientation measurement to update the propagated state; and determine a device pose estimate based on the updated state associated with the EKF.

In another example, a non-transitory computer-readable medium is provided that includes instructions that, when executed by at least one processor, cause the at least one processor to: obtain inertial measurement unit (IMU) data from an IMU associated with a device; determine, using the IMU data, a propagated state associated with an Extended Kalman Filter (EKF), wherein the propagated state includes an initial orientation estimate corresponding to a pose of the device; generate a predicted orientation measurement based on using a first machine learning network to process the IMU data and the initial orientation estimate included in the propagated state associated with the EKF; determine an updated state associated with the EKF, wherein the updated state is determined based on using the predicted orientation measurement to update the propagated state; and determine a device pose estimate based on the updated state associated with the EKF.

In another example, an apparatus is provided. The apparatus includes: means for obtaining inertial measurement unit (IMU) data from an IMU associated with a device; means for determining, using the IMU data, a propagated state associated with an Extended Kalman Filter (EKF), wherein the propagated state includes an initial orientation estimate corresponding to a pose of the device; means for generating a predicted orientation measurement based on using a first machine learning network to process the IMU data and the initial orientation estimate included in the propagated state associated with the EKF; means for determining an updated state associated with the EKF, wherein the updated state is determined based on using the predicted orientation measurement to update the propagated state; and means for determining a device pose estimate based on the updated state associated with the EKF.

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus includes at least one camera for capturing one or more images or video frames. For example, the apparatus(es) can include a camera (e.g., a red-green-blue (RGB) camera) or multiple cameras for capturing one or more images and/or one or more videos including video frames. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with some examples;

FIG. 3 is a block diagram illustrating an example of a device including an inertial measurement unit (IMU) and a pose estimation engine, in accordance with some examples;

FIG. 4A is a diagram illustrating an example of pose estimation using a machine learning (ML) model, in accordance with some examples;

FIG. 4B is a diagram illustrating an example of pose estimation using an ML model and a Kalman Filter (KF), in accordance with some examples;

FIG. 5 is a diagram illustrating an example of a machine learning system that can be used to perform pose estimation based on a learned orientation change measurement and state information associated with an Extended Kalman Filter (EKF), in accordance with some examples;

FIG. 6 is a diagram illustrating an example machine learning architecture that includes a respective encoder and decoder machine learning network for each of an orientation estimation engine, a velocity estimation engine, and a position estimation engine, in accordance with some examples;

FIG. 7A is a diagram illustrating a first example machine learning architecture that can be used to determine a learned orientation change measurement for pose estimation based on predicting quaternion information, in accordance with some examples;

FIG. 7B is a diagram illustrating a second example machine learning architecture for an orientation estimation engine that can be used to determine a learned orientation change measurement for pose estimation based on using a quaternion residual connection layer to predict error quaternion information, in accordance with some examples;

FIG. 8 is a flow chart diagram illustrating an example of a process for predicting pose information, in accordance with some examples;

FIG. 9 is a block diagram illustrating an example of a deep learning network, in accordance with some examples;

FIG. 10 is a block diagram illustrating an example of a convolutional neural network, in accordance with some examples; and

FIG. 11 illustrates a detailed example of a deep convolutional network (DCN) designed to recognize visual features from an image, in accordance with some examples;

FIG. 12 is a block diagram illustrating a deep convolutional network (DCN), in accordance with some examples; and

FIG. 13 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Inertial measurement units (IMUs) can be used to perform pose tracking corresponding to the position and orientation of an object in three-dimensional (3D) space. For example, six degrees of freedom (6DOF) pose information can include three degrees of freedom that represent the position of an object within 3D space, and three degrees of freedom that represent the orientation of the object within 3D space. Pose tracking can be performed based on measuring or determining the pose of an object over a plurality of different time steps or observations.

For example, first 6DOF pose information can be determined for an object at a first time and second 6DOF pose information can be determined for the object at a second time. The difference between the first 6DOF pose information and the second 6DOF pose information can correspond to the translational movement and the rotational movement of the object between the first and second times. For example, the first 6DOF pose information can include a respective first position of the object along each of three axes (e.g., x, y, z) at the first time, and a respective first orientation of the object about each of the three axes (e.g., pitch, roll, yaw) at the first time. The second 6DOF pose information can indicate a respective second position of the object along each of the same three axes at the second time, and a respective second orientation of the object about each of the same three axes at the second time.

The difference between pose information of an object determined at a first time and pose information of an object determined at a second time can correspond to the translational and rotational movements of the object, between the first and second times. For example, the difference between the first 6DOF pose information and the second 6DOF pose information can correspond to the translational movement of the object along each of the three axes (e.g., x, y, z) from the first time to the second time, and the rotational movement of the object about each of the three axes (e.g., x, y, z) from the first time to the second time.

For example, a first 6DOF pose estimate corresponding to the position and orientation of an object at a first time (e.g., a time t₁) can be represented as (x₁, y₁, z₁, z1, β₁, γ₁). The subset of values x₁, y₁, z₁ corresponds to the position of the object at the first time t₁ along the x-axis, the y-axis, and the z-axis (respectively). The subset of values α₁, β₁, γ₁ corresponds to the orientation of the object at the first time t₁ about the x-axis, the y-axis, and the z-axis (respectively). A second 6DOF pose estimate can be determined corresponding to the position and orientation of the object at a second time t₂, and can be represented as (x₂, y₂, z₂, z2, β₂, γ₂).

Pose tracking can be performed to estimate the pose of an object for a plurality of different times or observations (e.g., including the first time t₁, the second time 12, . . . , etc.). In some cases, pose tracking can be performed based on measuring the translational and/or rotational movements of the object, and using the measured translational and/or rotational movements to update the pose estimate from a previous time step. For example, one or more IMUs and/or other inertial sensors can be used to measure translational movements of an object as (Ax, Ay, Az), and/or can be used to measure rotational movements of an object as (Δα, Δβ, Δγ).

In some cases, 6DOF pose tracking can be performed based on using the 6DOF pose of an object at a first time t₁ and the translational and rotational movements of the object between the first time t₁ and a second time/2, to generate an estimate 6DOF pose of the object at the second time t₂. For example, based on the translational and rotational movements (Δx, Δy, Δz, Δα, Δβ, Δγ) of the object between the first time//and the second time t₂, the 6DOF pose at time t₂ can be estimated as (x₂, y₂, z₂, z2, β₂, γ₂)=(x₁+Δx, y₁+Δy, z₁+Δz, α₁+Δα, β₁+Δβ, γ₁+Δγ).

Pose tracking can be performed based on using IMUs or other inertial sensors to obtain translational and rotational movement (e.g., displacement) information of an object, and updating a previous pose estimate using the translational and rotational movement information. For example, an IMU may include one or more accelerometers, gyroscopes, and/or magnetometers that can be used to detect or measure linear acceleration and angular velocity. Based on attaching or coupling the IMU to the object (e.g., based on a shared reference frame between the IMU and the object), the linear acceleration and angular velocity measured by the IMU can be approximated as being equal to the linear acceleration and angular velocity, respectively, of the object. Based on integrating the measured linear acceleration and angular information over time, the 3D orientation, velocity, and/or position of the IMU, and the object to which the IMU is attached, can be determined.

IMU-based tracking (e.g., including IMU-based pose tracking) can experience drifts in accuracy, as sensor noise and/or IMU sensor bias accumulate over time in the calculated positions and orientations determined from the IMU sensor output. For example, integrating noisy and/or biased IMU sensor data can correspond to relatively rapid or significant drift in the accuracy of the subsequent pose estimates (e.g., drift in the position and heading angle estimates used for 6DOF pose tracking).

In some cases, sensor fusion 6DOF pose tracking techniques can utilize one or more additional physical measurements that are external to the IMU or inertial sensors, where the additional measurements are fused with the IMU sensor data to constrain, correct, and/or compensate for the IMU integration drift and/or IMU sensor bias challenges noted above. For example, sensor fusion 6DOF pose tracking techniques can use additional physical measurements such as image data obtained from a camera, location or position information obtained from a Global Position System (GPS) or Global Navigation Satellite System (GNSS) receiver, time-of-flight (ToF) or other depth information obtained from a ToF or depth sensor, etc., to perform sensor fusion for correcting or compensating position and/or orientation drift associated with the IMU sensor bias.

In some examples, machine learning techniques can be used with IMU or inertial-based 6DOF pose tracking. For example, learning-based inertial odometry can use one or more machine learning models to learn a statistical motion model from a dataset of IMU or other inertial measurements that are associated with ground truth 6DOF poses. The learned statistical motion machine learning model can subsequently be used to augment and/or constrain an IMU-based inertial odometry system to perform 6DOF pose tracking and obtain 6DOF pose estimates with lower drift (e.g., lower drift error, increased accuracy). In some cases, the learned statistical motion machine learning model can be used to stabilize the tracking system associated with performing IMU or inertial-based 6DOF pose tracking, and may fully or partially replace the physical measurements.

In some examples of 6DOF pose tracking techniques, machine learning-based learned measurement can be combined with sensor fusion and/or additional physical measurements such as image data, GPS location, ToF depth information, etc., to improve the baseline IMU dead-reckoning inertial odometry performance. In some cases, the use of machine learning-based learned measurement techniques can reduce the wake-up frequency or triggering rate of performing the dependent physical measurements associated with the sensor fusion 6DOF pose tracking techniques.

The additional or dependent physical measurements (e.g., image data, GPS data, ToF or depth information, etc.) associated with sensor fusion-based 6DOF pose tracking techniques may require the use of relatively complex and/or high-cost sensor components, while IMUs and other inertial sensors are often relatively low-cost and high update rate sensors. Systems and techniques that can be used to perform IMU-based inertial 6DOF pose tracking, with IMU sensor bias and/or drift compensation without utilizing sensor fusion or additional physical measurements, may be desirable.

In some examples of machine learning-based 6DOF pose tracking techniques, one or more machine learning networks may be used to learn full 3D motion models to predict a 3D displacement vector and the covariance between two IMU poses over a fixed window size. The 3D displacement vector and covariance predicted by the machine learning network may be integrated into an Extended Kalman Filter (EKF) or other linear quadratic estimation engine and/or nonlinear quadratic estimation engine as pose graph constraints to estimate a full 6DOF pose. In some examples, an EKF can be implemented as a linear approximation of a nonlinear model around a current estimate. For example, an EKF filtering process can correspond to a nonlinear version and/or nonlinear implementation of Kalman filtering, where the EKF filtering linearizes about an estimate of a current mean and covariance corresponding to current filter state information. As used herein, an EKF may also be referred to as a “state estimation engine” and/or a “recursive probabilistic filter.” In some examples, a “state estimation engine” can correspond to one or more of an EKF, a Kalman Filter, a linear quadratic estimation engine, a nonlinear quadratic estimation engine, etc. Learning a 3D displacement or velocity vector between IMU poses, and subsequently using the learned 3D displacement or velocity vector to correct or replace IMU state propagation (e.g., during integration into the EKF), can correspond to an under-determined measurement model for the 6DOF pose. For example, the learned 3D displacement or velocity vector represents 3DOF information (e.g., three degrees of freedom, corresponding to the three dimensions of the displacement or velocity vector), and does not directly measure or represent the orientation state of an object. Machine learning-based 6DOF pose tracking techniques that use learned or predicted 3D displacement or velocity vectors may be under-determined systems for predicting 6DOF pose, and may be unstable when unobserved state changes occur. There is a need for systems and techniques that can be used to perform IMU-based 6DOF pose tracking using one or more machine learning networks to provide learned position change measurements (e.g., learned or predicted 3D displacement or velocity vectors) and learned orientation change measurements (e.g., learned or predicted 3D rotation or angular velocity vectors).

Systems, apparatuses, methods (also referred to as processes), and computer-readable media (collectively referred to as “systems and techniques”) are described herein that can be used to perform pose tracking using one or more machine learning networks to determine (e.g., predict) a learned orientation change measurement corresponding to orientation and/or rotation-based state variables of the pose tracking system. For example, the systems and techniques can be used to perform IMU-based (e.g., inertial-based) 6DOF pose tracking, based on using one or more machine learning networks to implement a learned orientation change measurement corresponding to orientation-based state variables (e.g., such as orientation, gyroscope bias, IMU rotational or angular bias, etc.).

In some examples, the systems and techniques can implement a learned three-dimensional (3D) relative rotation measurement (e.g., learned orientation change measurement) based on a quaternion representation. Quaternions are a four-dimensional (4D) representation of 3D rotations, and may be used for orientation estimation. For example, the systems and techniques can utilize a sequence-to-sequence regression Transformer machine learning architecture, which can be configured to query orientation information for or between any arbitrary timeslot(s). The learned orientation change measurement information can be provided as feedback to a state estimation engine, and can be used to determine an updated state for the state estimation engine. In some examples, the state estimation engine can be an Extended Kalman Filter (EKF) or other linear and/or nonlinear quadratic estimation engine associated with the 6DOF pose tracking. Based on the learned orientation change measurement information obtained as a feedback input to the EKF, a filter update can be performed to update the state and covariance associated with the EKF (e.g., where the EKF state and covariance correspond to an estimated 6DOF pose for the current time step).

In some cases, the EKF propagated quaternion series can be provided as a decoder input to one or more Transformer decoders included in the sequence-to-sequence regression Transformer machine learning architecture. Based on the EKF propagated quaternion series being used as a decoder input to the one or more Transformer decoders of the 6DOF pose tracking system, the Transformer machine learning architecture can be configured as a smoother and decoder masking is not performed to generate an estimated 6DOF pose. In some examples, the systems and techniques can utilize quaternion self-supervision in a self-attention decoding task. For example, the systems and techniques can use a random binomial sign modulated self-supervision loss to enforce antipodal sign symmetry during learning. The random binomial sign modulated self-supervision loss can be configured for decoder self-attention with unit quaternion input, based on the decoder learning to enforce antipodal sign symmetry to improve generalization performance to the quaternion antipodal problem (e.g., a unit quaternion double covers the SO(3) space, where the quaternions \hat{q} and −q represent the same rotation based on antipodal sign symmetry).

Various aspects of the present disclosure will be described with respect to the figures.

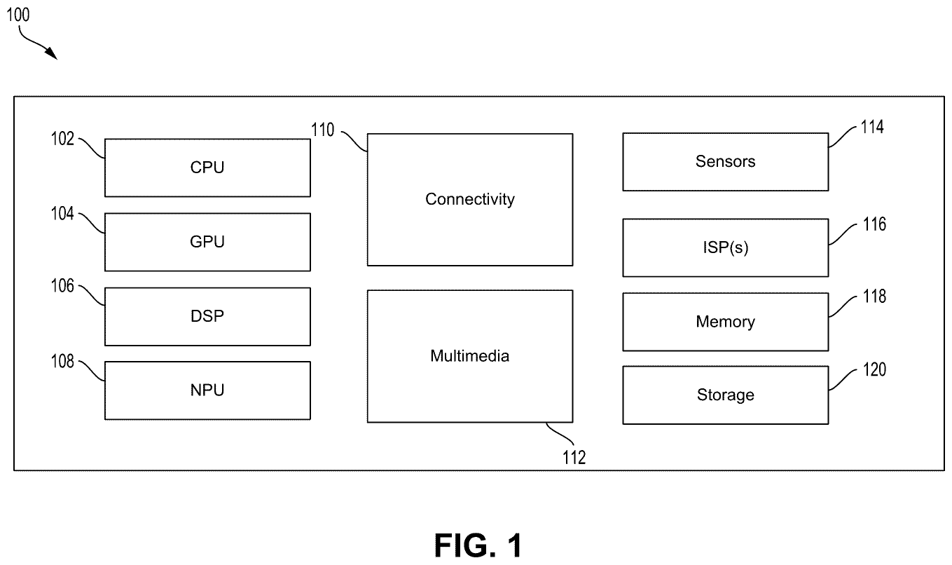

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or May be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IOT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

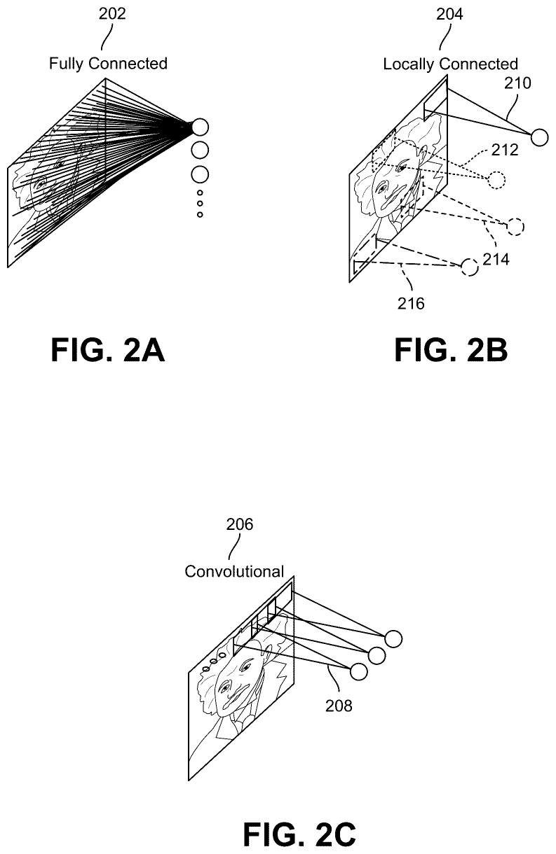

The connections between layers of a neural network may be fully connected or locally connected. FIG. 2A illustrates an example of a fully connected neural network 202. In a fully connected neural network 202, a neuron in a first hidden layer May communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

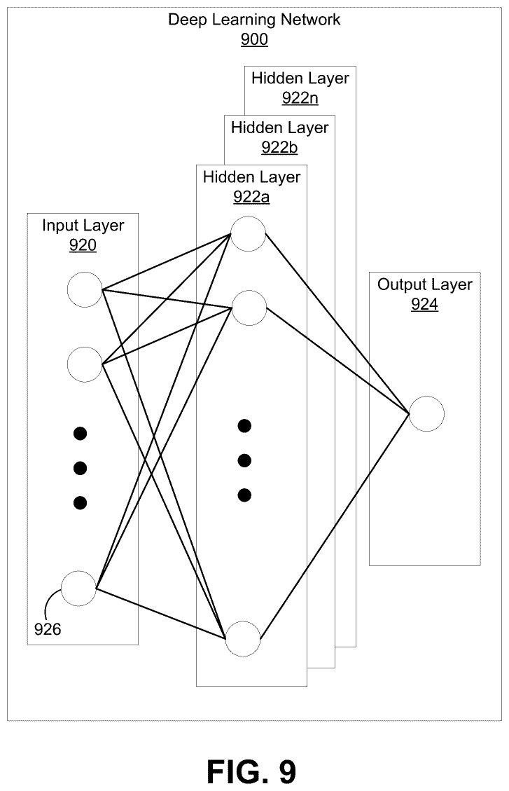

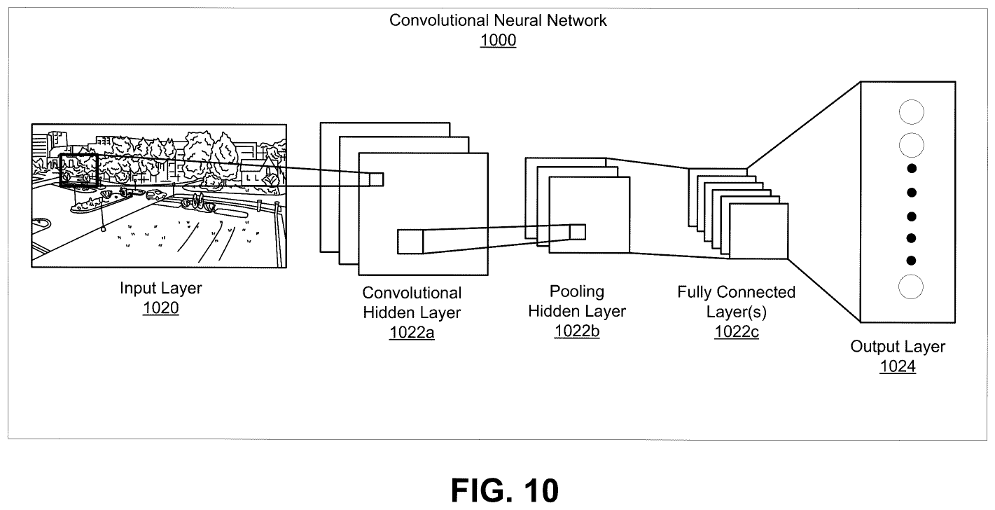

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 9. Illustrative examples of convolutional neural networks are described in greater depth with respect to the example block diagrams of FIGS. 10-12.

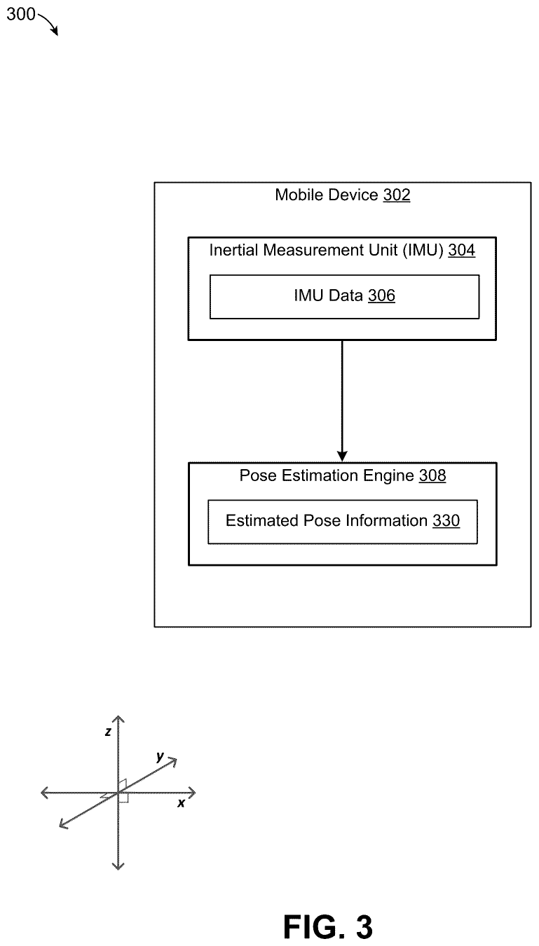

FIG. 3 is a block diagram illustrating an example of a device 302 including an inertial measurement unit (IMU) 304 and a pose estimation engine 308, in accordance with some examples. The device 302 can be provided within an operating environment 300, comprising a 3D space associated with a first axis (e.g., the x-axis of FIG. 3), a second axis (e.g., the y-axis of FIG. 3), and a third axis (e.g., the z-axis of FIG. 3). In some aspects, the device 302 can be a mobile device of a user, and may be a smartphone, a mobile computing device, an XR device, a head-mounted device (HMD), a wearable device, etc. Within the operating environment 300, the pose estimation engine 308 of the mobile device 302 can perform pose tracking and/or pose estimation as the mobile device 302 moves in three-dimensional space. In some examples, the mobile device 302 can include or implement the SOC 100 of FIG. 1. For example, the IMU 304 can be included in the sensors 114 of FIG. 1, etc.

As the mobile device 302 moves, the IMU 304 can generate corresponding IMU data 306. The pose estimation engine 308 can use the IMU data 306 to determine one or more estimates of the translational and/or rotational motion of the mobile device 302. For example, based on the IMU data 306, the pose estimation engine 308 can determine estimates of translational and/or rotational motion of the mobile device 302 with respect to up to six degrees of freedom (6DOF). In some examples, the six degrees of freedom can correspond to translational motion along, and rotational motion about, three axes of the three-dimensional space of the operating environment 300. Each of the three axes can correspond to a respective one of three directions defined by coordinate axes for the three-dimensional space. In the depicted example, the coordinate axes define an x direction, a y direction, and a z direction, and the six degrees of freedom can correspond to translational motion in the x, y, and z directions and rotational motion about the x, y, and z directions.

In some cases, the pose estimation engine 308 can use the IMU data 306 to determine estimates of the translational motion of the mobile device 302, without determining estimates of the rotational motion of the mobile device 302. In some cases, the pose estimation engine 308 can be configured to use the IMU data 306 to determine estimates of the rotational motion of the mobile device 302, without determining estimates of the translational motion of the mobile device 302. In some aspects, the pose estimation engine 308 can be configured to use the IMU data 306 to determine one or more estimates of the translational motion of the mobile device 302 and to determine one or more estimates of the rotational motion of the mobile device 302. In some examples, the pose estimation engine 308 can determine estimates of one or both of translational motion and rotational motion of the mobile device 302 with respect to less than three coordinate dimensions. In one example, the pose estimation engine 308 may determine estimates of translational motion, rotational motion, or both, with respect to the x and z dimensions, but not with respect to the y dimension.

Based on the estimates of translational and/or rotational motion of the mobile device 302 (e.g., determined by the pose estimation engine 308 and using the IMU data 306), the pose estimation engine 308 can determine estimated pose information 330. For example, the estimated pose information 330 can include and/or may correspond to one or more device pose estimates for the pose of the mobile device 302. In some aspects, the pose estimation engine 308 can be a 6DOF pose estimation engine that is configured to generate the estimated pose information 330 as estimated 6DOF pose information. In some examples, the estimated pose information 330 includes one or more device pose estimates, where each device pose estimate is indicative of an estimated position and/or an estimated orientation of the mobile device 302 in terms of one or more dimensions of the coordinate system defined by the x, y, and z axes. For example, when the estimated pose information 330 comprises estimated 6DOF pose information, each device pose estimate can be indicative of an estimated position along the x, y, and z axes (e.g., a first, second, and third degree of freedom of the estimated pose information, respectively) and can be indicative of an estimated rotation with respect to or about the x, y, and z axes (e.g., a fourth, fifth, and sixth degree of freedom of the estimated pose information, respectively).

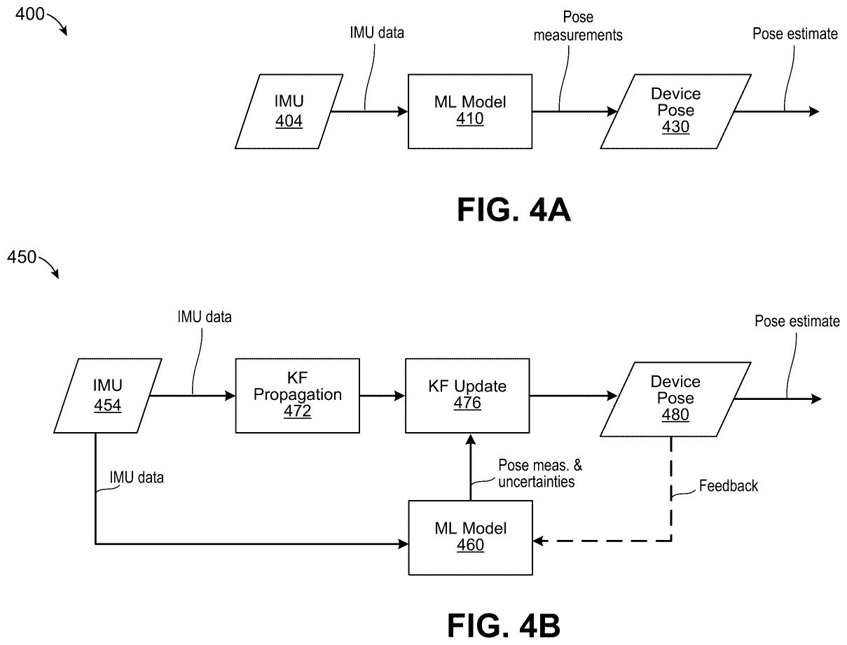

FIG. 4A is a diagram illustrating an example of pose estimation system 400 that can perform a pose estimation technique using one or more machine learning (ML) models, in accordance with some examples. In some examples, the pose estimation system 400 can be included as part of the mobile device 302 and/or the pose estimation engine 308 of FIG. 3. For example, the pose estimation system 400 of FIG. 4A can perform the pose estimation technique based on an IMU 404 and IMU data obtained using the IMU 404. In some examples, the IMU 404 can be the same as or similar to the IMU 304 of FIG. 3, and the IMU data generated by the IMU 404 of FIG. 4A can be the same as or similar to the IMU data 306 generated by the IMU 304 of FIG. 3. In some cases, the device pose 430 of FIG. 4A can be the same as or similar to the estimated pose information 330 of FIG. 3.

As illustrated in FIG. 4A, the pose estimation system 400 includes a machine learning (ML) model 410 used to generate pose measurements based on IMU data obtained by the IMU. 404. For example, the ML model 410 can receive as input the IMU data obtained by the IMU 404, and the ML model 410 can generate as output one or more pose measurements generated based on the input IMU data. In some cases, the one or more pose measurements determined by the ML model 410 can include three translational motion measurements (e.g., corresponding to three position measurements and/or translational motions along each respective axis of the three axes associated with a 3D space). For example, for each of three dimensions, the pose measurements determined by the ML model 410 can include a respective translational motion measurement that represents translational motion in the particular dimension. In some cases, the pose measurements may include a respective position measurement that implies and/or is indicative of the respective translational motion measurement along a particular axis or dimension.

The pose measurements determined by the ML model 410 can additionally include three rotational motion measurements corresponding to rotation about each respective axis of the three axes. In some cases, the pose measurements determined by the ML model 410 may include three orientation measurements that imply and/or are indicative of the respective rotational motion measurement about each respective axis of the three axes. For example, for each of the three dimensions, the pose measurements determined by the ML model 410 can include a respective rotational motion measurement that represents rotational motion about the particular dimension or axis. In some cases, the device pose estimate 430 can be determined directly from or based on the pose measurements generated by the ML model 410. For example, the device pose estimate 430 can be the same as or similar to the estimated pose information 330 of FIG. 3. In some cases, the device pose estimate 430 can be determined based on or using the ML model 410, and can be provided to a client.

FIG. 4B is a diagram illustrating an example of pose estimation system 450, which may perform a pose estimation technique using one or more ML models and a Kalman Filter (KF). In some examples, the pose estimation system 450 of FIG. 4B can be part of the mobile device 302 and/or the pose estimation engine 308 of FIG. 3. For example, the pose estimation system 450 of FIG. 4B can include an IMU 454 and can perform the pose estimation technique using IMU data obtained using the IMU 454. In some examples, the IMU 454 of FIG. 4B can be the same as or similar to the IMU 304 of FIG. 3 and/or the IMU 404 of FIG. 4A, etc. The IMU data generated by the IMU 454 of FIG. 4B can be the same as or similar to the IMU data 306 generated by the IMU 304 of FIG. 3, and/or the IMU data generated by the IMU 404 of FIG. 4A, etc. In some cases, the ML model 460 of FIG. 4B can be the same as or similar to the ML model 410 of FIG. 4A. The device pose estimate 480 determined using the pose estimation system 450 of FIG. 4B can be the same as or similar to the estimated pose information 330 of FIG. 3, and/or the device pose estimate 430 determined using the pose estimation system 400 of FIG. 4A, etc.

In both the pose estimation system 400 of FIG. 4A and the pose estimation system 450 of FIG. 4B, a device pose estimate can be determined based on pose measurements generated using a machine learning model (e.g., ML model 410 and ML model 460, respectively). In the example of the pose estimation system 400 of FIG. 4A, the determination of the device pose estimate 430 is performed directly based on the pose measurements generated by the ML model 410. In the example of the pose estimation system 450 of FIG. 4B, the determination of the device pose estimate 480 is performed indirectly based on the pose measurements generated by the ML model 460.

In one illustrative example, the pose estimation technique performed by the pose estimation system 450 of FIG. 4B can be an indirect pose estimation technique, where the device pose estimate 480 is determined as an estimated system state that is tracked and updated using a Kalman Filter (KF) (e.g., using Kalman filtering with one or more Kalman Filters, also referred to herein as “KF filtering”). For example, the Kalman Filter (e.g., the KF filtering) used for the indirect pose estimation technique performed by the pose estimation system 450 of FIG. 4B can be implemented based on the KF propagation 472 and the KF update 476, provided between the IMU 454 data input and the ML model 460. Kalman filtering can also be referred to as linear quadratic estimation. As noted above, in some aspects, an Extended Kalman Filter (EKF) (e.g., a state estimation engine associated with performing and/or configured to perform extended Kalman filtering) can be implemented based on a linear approximation of a nonlinear model around a current estimate.

In some aspects, IMU data can be obtained by the IMU 454, and provided to both the Kalman filter and the ML model 460 for processing. The same IMU data can be processed by the Kalman filter and the ML model 460. For example, the IMU data obtained by the IMU 454 can be propagated to the Kalman filter, based on the IMU data being provided from the IMU 454 to the KF propagation 472. The same IMU data can additionally be provided from the IMU 454 to the input of the ML model 460, where the ML model 460 uses the IMU data to generate as output one or more pose measurements and corresponding uncertainty information of the one or more pose measurements.

As noted above, the pose measurements generated by the ML model 460 from the IMU data obtained from the IMU 454 can include three translational motion measurements including a respective translational motion measurement for each of three dimensions (or position measurements indicative of the translational motion measurements), and three rotational motion measurements including a respective rotational motion measurement for each of the three dimensions (or orientation measurements indicative of the rotational motion measurements). The ML model 460 can additionally generate corresponding uncertainties (e.g., uncertainty information) associated with the pose measurements. For example, the output of the ML model 460 can include or indicate respective uncertainties (e.g., respective uncertainty information) for each of the three translational motion (or position) measurements and each of the three rotational motion (or orientation) measurements. In some aspects, the ML model 460 can generate 6DOF pose measurements or 6DOF pose information based on the IMU data from the IMU 454, and can additionally generate six corresponding uncertainties for the six degrees of freedom represented within the 6DOF pose information determined by the ML model 460.

In some cases, the ML model 460 can be configured to generate the pose measurements based on a time interval value. For example, the time interval value can indicate or represent an amount of time across which changes in position and orientation (e.g., as a result of translational and rotational motion, respectively) are to be measured by the IMU 454 and IMU data, and represented by the ML model 460 in the output pose measurements and uncertainties. For example, if the ML model 460 generates the pose measurements using a time interval value of 1 second, the pose measurements can include translational motion measurements and rotational motion measurements corresponding to changes in position and orientation, respectively, occurring over a particular 1 second interval in time.

The IMU data from the IMU 454 is propagated to the Kalman filter at the KF propagation block 472. The Kalman filter can subsequently be updated (e.g., at the KF update block 476) based on the pose measurements and uncertainties determined by the ML model 460. The pose measurements and uncertainties determined by the ML model 460, and used to update the Kalman filter at the KF update block 476, are based on the same IMU data that was also propagated to the Kalman filter at the KF propagation block 472. For example, the update to the Kalman filter implemented at the KF update 476 can be performed based on a combination of the IMU data being propagated to the Kalman filter (e.g., at KF propagation block 472) and being processed by the ML model 460 to determine the pose measurements and uncertainties used for the update.

In some aspects, the Kalman filter can be iteratively or repeatedly updated. For example, the Kalman filter can be updated for each time step of a plurality of time steps. The update can be based on propagating to the Kalman filter (e.g., KF propagation 472) the IMU data obtained by the IMU 454 for the current time step, and subsequently updating the Kalman filter (e.g., KF update 476) based on the ML model 460 pose measurements and uncertainty information determined from analyzing the same IMU data obtained by the IMU 454 for the current time step.

As noted previously, in one illustrative example, the indirect pose estimation system 450 of FIG. 4B can perform a pose estimation technique based on determining the device pose estimate 480 as an estimated system state that is tracked and updated using the Kalman filter. For example, each time the Kalman filter is updated at KF update 476, the pose measurements and uncertainties generated using the ML model 460 can be used as bases for correction of the estimated system state of the Kalman filter. In one illustrative example, correcting the estimated system state of the Kalman filter at the KF update block 476 corresponds to correcting the pose estimate 480.

In some aspects, upon completion of any given update of the Kalman filter 476, the pose estimate 480 of the device can be determined based on the estimated system state of the updated Kalman filter. In some examples, the pose estimate 480 can be determined for the current time step based on the KF update 476 performed for the current time step, and the pose estimate 480 can be provided to a client. In some aspects, the pose estimate 480 can be determined for the current time step, and can be fed back to the ML model 460 as an additional input for generating pose measurements and uncertainties for a next time step and/or a next Kalman filter update. In some examples, the pose estimate 480 can be determined for the current time step, and can be both provided as output (e.g., to a client) and provided as the feedback input to the ML model 460 for the next time step or next KF update 476.

As noted previously, the systems and techniques described herein can be used to perform pose tracking using one or more machine learning networks to determine (e.g., predict) a learned orientation measurement corresponding to orientation and/or rotation-based state variables of the pose tracking system. In some aspects, the learned orientation measurement can be a learned orientation change measurement and/or can be a learned absolute orientation prediction. In some aspects, the systems and techniques can perform 6DOF pose tracking using a learned position (e.g., displacement and/or velocity) change measurement, and the learned orientation measurement.

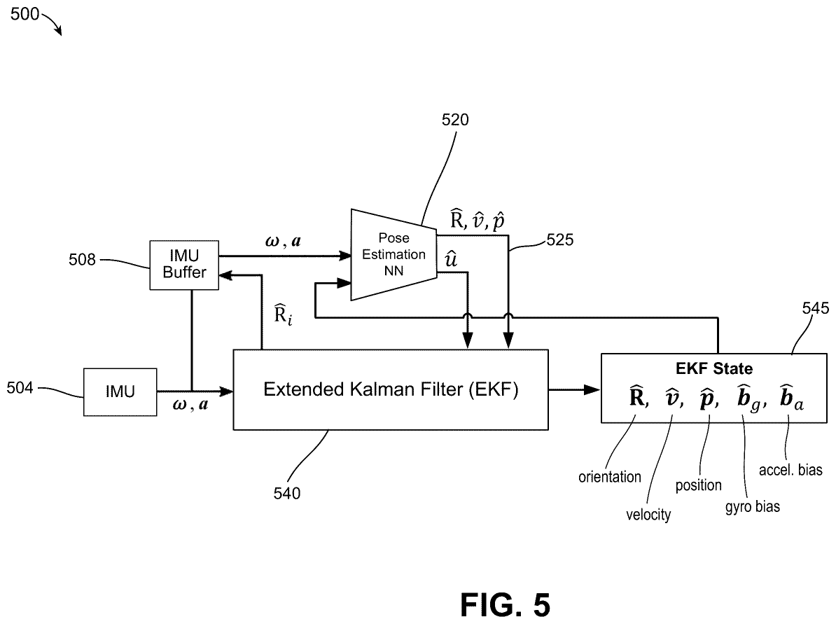

For example, FIG. 5 is a diagram illustrating an example of a machine learning system 500 that can be used to perform pose estimation based on a learned orientation measurement (e.g., learned orientation change and/or absolute orientation prediction) determined using a pose estimation neural network 520, and state information 545 associated with a state estimation engine 540. In some aspects, the state estimation engine 540 can be implemented as an Extended Kalman Filter (EKF) 540, in accordance with some examples. As used herein, the state estimation engine 540 can be interchangeably referred to as the EKF 540, and vice versa. In other aspects, the state estimation engine 540 can include another type of linear quadratic estimation engine and/or nonlinear quadratic estimation engine.

In some aspects, the machine learning system 500 can include an IMU 504 that is the same as or similar to the IMU 304 of FIG. 3, the IMU 404 of FIG. 4A, and/or the IMU 454 of FIG. 4B, etc. The IMU 504 of FIG. 5 can be used to determine linear acceleration a and angular velocity w information, which can be provided from the IMU 504 to the input of the EKF 540. The linear acceleration a and angular velocity @ information can additionally be provided from the IMU 504 to an IMU buffer 508. The IMU buffer 508 can store measurement information obtained by the IMU 504 for a plurality of previous time steps or time windows. For example, the IMU 504 can determine linear acceleration and angular velocity information (a, w) for a current time step 1, which can be stored in the IMU buffer 508 along with the respective linear acceleration and angular velocity information (a, w) determined by the IMU 504 for one or more (or a plurality) of earlier time steps prior to the current time step 1.

The raw IMU data (w, a) can be fed from the IMU 504 to an input of the EKF 540. For example, the IMU 504 can provide the measured IMU data (w, a) to a propagation system within the EKF 540 (e.g., such as the KF propagation block 472 of FIG. 4B), which is configured to propagate the pose or trajectory information into the current time slot, given the IMU data (w, a). In some aspects, the EKF 540 can generate propagated orientation information \hat{R}i, based at least in part on the IMU data (w, a) obtained for the current time step by the IMU 504. The EKF can provide the propagated orientation information \hat{R}i to the IMU buffer 508, which can store the propagated orientation information \hat{R}i and the IMU data (w, a) for a plurality of previous time steps of the machine learning system 500 and/or the 6DOF pose tracking performed using the machine learning system 500.

In addition to the propagated orientation information \hat{R}i, provided from the EKF 540 to the IMU buffer 508, the EKF 540 can additionally determine one or more estimates of an EKF state 545. For example, the EKF state 545 can include and/or be indicative of an estimated orientation \hat{R}, an estimated velocity \hat{v}, and estimated position \hat{p}, a gyroscope bias \hat{b}_{g} (e.g., a bias associated with a gyroscope included in the IMU 504 and/or associated with gyroscopic angular velocity information w determined by the IMU 504), and an accelerometer bias \hat{b}ₐ (e.g., a bias associated with an accelerometer included in the IMU 504 and/or associated with linear acceleration information a determined by the IMU 504).

In one illustrative example, the EKF 540 can perform propagation using the IMU data (w, a) and can determine an initial estimate for the EKF state 545. The initial estimate for the EKF state 545 can be provided as a feedback input to the pose estimation neural network 520, which can be configured to generate a refined estimate 525 (or refined estimates 525) of the orientation \hat{R}, velocity \hat{v}, and position \hat{p}. The refined estimate 525 determined by the pose estimation neural network 520 can be provided as an additional input to the EKF 540, and the EKF 540 can use the refined estimate 525 to perform a filter update to generate as output a refined EKF state 545. In some aspects, the EKF 540 can perform a filter update using the refined estimate 525, where the filter update is the same as or similar to the KF update 476 of FIG. 4B.

The pose estimation neural network 520 can generate as output the refined estimate 525, indicative of the refined estimate for the orientation \hat{R}, velocity \hat{v}, and position \hat{p}. The pose estimation neural network 520 can additionally generate as output uncertainty information û, which can include or indicate a respective uncertainty for each quantity in the refined estimate 525 (e.g., the uncertainty information û can be indicative of a first uncertainty associated with the refined orientation estimate \hat{R} determined by the pose estimation neural network 520, a second uncertainty associated with the refined velocity estimate \hat{v} determined by the pose estimation neural network 520, and a third uncertainty associated with the refined position estimate \hat{p} determined by the pose estimation neural network 520). In some aspects, the refined estimates 525 and the corresponding uncertainty information û generated by the pose estimation neural network 520 can both be provided as inputs to the KF update performed by the EKF 540 to generate the updated or refined EKF state information 545.

The pose estimation neural network 520 can generate the refined estimates 525 for the orientation \hat{R}, velocity \hat{v}, and position \hat{p}, and the corresponding uncertainty information û, based on a first input comprising IMU data (w, a) obtained from the IMU buffer 508 and corresponding to angular velocity and linear acceleration measured by the IMU 504, and a second input comprising the initial estimate of the EKF state 545 that is determined by the EKF 540 before the KF update is performed.

In some aspects, the pose estimation neural network 520 is configured (e.g., trained) to regress the 3D orientation \hat{R}, the velocity, the position \hat{p}, and the corresponding uncertainty û between two time instants, given the segment or portion of IMU data (e.g., obtained from the IMU buffer 508) between the two time instants. For example, the pose estimation neural network can infer rotational displacement or rotational movement (e.g., corresponding to the estimated 3D orientation \hat{R}) over a short timespan from acceleration and angular velocity measurements (e.g., obtained from the IMU buffer 508) and the initial estimate of the EKF state 545 provided as feedback from the EKF 540.

In some aspects, the pose estimation neural network 520 can be used to determine a refined 6DOF pose estimate that is used to perform the filter update for the EKF 540 and to generate the updated or refined EKF state 545 for the current time step of the 6DOF pose tracking machine learning system 500. For example, the position estimate \hat{p} can be 3D position information that corresponds to the three translational or positional degrees of freedom of a 6DOF pose (e.g., translation or position along each of the x, y, and z axes). The orientation estimate \hat{R} can be 3D orientation or rotation information that corresponds to the three rotational or angular degrees of freedom of a 6DOF pose (e.g., rotation or angular orientation (heading) about each of the x, y, and z axes).

In some examples, the EKF state 545 generated as output by the EKF 540 for the current time step can be generated based on the EKF 540 performing the filter update to fuse or combine the initial estimate determined based on the propagation step of the EKF 540 with the refined estimate 525 determined by the pose estimation neural network 520. For example, the EKF 540 can generate the EKF state 545 based on fusing the initial estimated orientation information \hat{R}ᵢ (e.g., determined based on the EKF 540 propagation) with the refined orientation information \hat{R} included in the refined estimates 525 generated by the pose estimation neural network 520. In some aspects, the EKF 540 can generate the EKF state 545 based on a weighted average between the initial estimate determined from the EKF 540 propagation step, and the refined estimate 525 determined by the pose estimation neural network 520.

For example, the refined orientation information \hat{R} (e.g., the predicted orientation measurement determined by the pose estimation neural network 520) can be weighted based on the corresponding uncertainty û of the prediction. The uncertainty-weighted predicted orientation measurement from the pose estimation neural network 520 can subsequently be fused with the initial orientation estimate \hat{R}ᵢ of the EKF 545. For example, uncertainty-based weighting to fuse the ML-predicted orientation \hat{R} with the initial EKF orientation estimate \hat{R}ᵢ can correspond to using relatively small weight values for relatively high predicted orientation measurement uncertainties û (e.g., the relatively high uncertainty ML-predicted orientation \hat{R} is weighted to cause a smaller correction in the EKF state 545 prediction), and can correspond to using relatively large weight values for relatively low predicted orientation measurement uncertainties û (e.g., the relatively low uncertainty ML-predicted orientation \hat{R} is weighted to cause a larger correction in the EKF state 545 prediction).

In some aspects, the IMU buffer 508 can be used to store and/or maintain history information of the EKF state 545 and/or history information of the orientation estimate information \hat{R}. In one illustrative example, the input provided to the pose estimation neural network 520 from the IMU buffer 508 can include the IMU data (w, a) obtained by the IMU 504 between the two time instants for which the pose estimation neural network 520 is configured to regress the refined estimates 525 (e.g., the refined orientation and position information, such as the refined 6DOF pose information based on the refined orientation \hat{R} representing three rotational degrees of freedom of the 6DOF pose and the refined position information \hat{p} representing the three translational degrees of freedom of the 6DOF pose).

The input provided to the pose estimation neural network 520 from the IMU buffer 508 can additionally include history orientation information corresponding to the \hat{R} orientation between the same two time instants for which the pose estimation neural network 520 is configured to regress the refined 6DOF pose information 525, and can include the current estimate of the orientation determined by the EKF 540 (e.g., the estimated orientation \hat{R}ᵢ. For example, the pose estimation neural network 520 can perform the regression to generate the refined 6DOF pose information 525 between a first and second time instant t and t₁ (respectively), where the time between t and t₁ corresponds to a first time step or first time slot of the machine learning 6DOF pose tracking system 500.

The inputs to the pose estimation neural network 520 from the IMU buffer 508 can include the IMU data (w, a) obtained by the IMU 504 for the first time slot between t and 11, and can further include the history orientation information stored in the IMU buffer 508 for the first time slot between/and 11. The inputs to the pose estimation neural network 520 from the IMU buffer 508 can additionally include the current or initial orientation estimate Ri, determined by the EKF 540 as a projection of the EKF state 545 one time slot into the future (e.g., the time slot starting from 11), where the projection is based on the EKF 540 propagating the input sample of IMU data (w, a) provided by the IMU 504 to the EKF 540.

In one illustrative example, the systems and techniques can implement 6DOF pose tracking using a learned orientation measurement (e.g., orientation change and/or absolute orientation prediction), where the learned orientation measurement corresponds to the orientation information \hat{R} generated as the refined pose information (e.g., refined estimates 525) output by the pose estimation neural network 520. In some aspects, the learned orientation measurement (e.g., \hat{R} generated by the pose estimation neural network 520) can be used to implement a 6DOF pose tracking system that is fully or properly determined, for example based on the EKF 540 filter update being performed using complete 6DOF information corresponding to the orientation \hat{R} and position \hat{p}information included in the refined estimates 525 from the pose estimation neural network 520). For example, the systems and techniques can use the learned orientation measurement (e.g., orientation change and/or absolute orientation prediction) to inform the 6DOF tracking system about orientation-related state variables for the EKF state 545 (e.g., the orientation state variable \hat{R} and the gyroscope bias state variable \hat{b}_{g} within the EKF state 545 can be based on the learned orientation measurement \hat{R} (of the refined estimates 525) from the pose estimation neural network 520). In one illustrative example, the learned network measurement information (e.g., the refined estimates 525) is fed back to the EKF 540 to perform the filter update (e.g., to update the Kalman filter of the EKF 540, for example based on the KF update 476 of FIG. 4B, etc.) to the EKF state 545 and covariance.

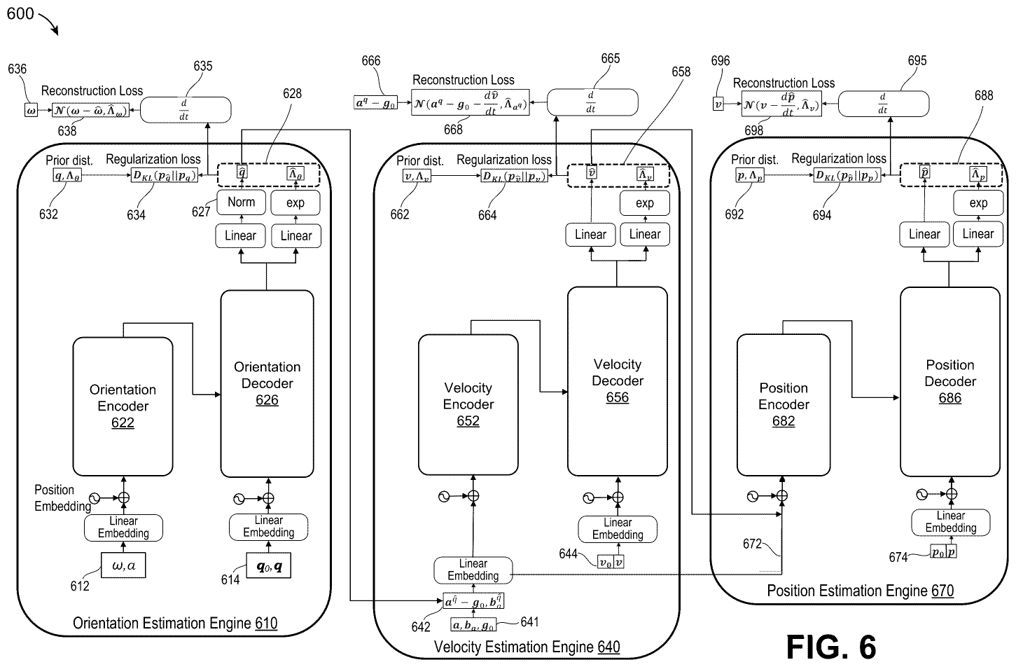

In some aspects, the pose estimation neural network 520 can utilize a sequence-to-sequence regression Transformer machine learning architecture, which can be configured to query orientation information for or between any arbitrary timeslot(s). For example, the pose estimation neural network 520 of FIG. 5 can be implemented based on the Transformer machine learning architecture 600 of FIG. 6. In one illustrative example, the pose estimation neural network 520 of FIG. 5 and/or the example Transformer-based machine learning architecture 600 of FIG. 6 can be configured to generate the learned network measurement information 520 (e.g., the learned orientation measurement \hat{R} of the refined estimates 525 and the learned position change measurement \hat{p} of the refined estimates 525) without performing autoregressive decoding.

Autoregressive decoding techniques can be associated with sequence generation tasks, and are implemented based on configuring a machine learning model (or decoder thereof) to predict the output sequence one element at a time, using the previously generated elements as additional input when predicting the next element (e.g., predict token₁ from token₀, predict token₂ from [token₀+token₁], predict token₃ from [token₀+token₁+token₂], . . . , etc.). In one illustrative example, the pose estimation neural network 520 of FIG. 5 and/or the example Transformer-based machine learning architecture 600 of FIG. 6 can be configured to implement a smoother (e.g., perform smoothing) over the entire input window (e.g., the current time slot between the two time instants/and 11, etc.), where the Transformer decoder can freely view the whole input window to generate the corresponding output (e.g., the refined estimates 525) without performing masking (e.g., as would be performed in an autoregressive decoder)

In some aspects, the systems and techniques can implement the pose estimation neural network 520 of FIG. 5 and/or the example Transformer-based machine learning architecture 600 of FIG. 6 using a sequence-to-sequence regression Transformer architecture, where the regression is performed between a complete input sequence (e.g., the whole window of input data between the time slot start/and time slot end t, provided from the IMU buffer 508 to the pose estimation neural network 520 of FIG. 5) and the complete output sequence (e.g., the corresponding refined or learned network measurement information (e.g., the refined estimates 525) generated by the pose estimation neural network 520 of FIG. 5).

FIG. 6 is a diagram illustrating an example machine learning architecture 600 that can be used to generate a learned orientation measurement (e.g., learned orientation change and/or absolute orientation prediction) for 6DOF pose tracking, in accordance with some examples. The example machine learning architecture 600 includes a respective encoder and decoder machine learning network for each of an orientation estimation engine 610 (e.g., including an orientation encoder 622 and an orientation decoder 626), a velocity estimation engine 640 (e.g., including a velocity encoder 652 and a velocity decoder 656), and a position estimation engine 670 (e.g., including a position encoder 682 and a position decoder 686).

In one illustrative example, the machine learning architecture 600 of FIG. 6 can be used to implement the pose estimation neural network 520 of FIG. 5. For example, the pose estimation neural network 520 of FIG. 5 can include the orientation estimation engine 610, the velocity estimation engine 640, and the position estimation engine 670 of the machine learning architecture 600 of FIG. 6.

In some aspects, the learned network measurement (e.g., the refined estimates 525) generated by the pose estimation neural network 520 of FIG. 5 (e.g., including the refined orientation estimate \hat{R}, the refined velocity estimate \hat{v}, and the refined position estimate \hat{p}) can correspond to the respective output 628 of the orientation estimation engine 610, the respective output 658 of the velocity estimation engine 640, and the respective output 688 of the position estimation engine 670 of FIG. 6.

For example, the orientation estimation engine 610 can be used to generate an orientation output 628 that includes a unit norm quaternion \hat{q} indicative of orientation information that can be the same as or similar to the orientation \hat{R} included in the learned network measurement (e.g., the refined estimates 525) of FIG. 5. The orientation output 628 generated by the orientation estimation engine 610 can further include orientation uncertainty information \hat{Λ}_{θ} corresponding to the orientation quaternion \hat{q}. For example, the orientation uncertainty information \hat{Λ}_{θ} can be indicative of a confidence or covariance term associated with the orientation quaternion \hat{q} generated by the orientation estimation engine 610 and included in the orientation output 628 of FIG. 6. In some cases, the orientation uncertainty information \hat{Λ}_{θ} can be a covariance matrix corresponding to the orientation quaternion \hat{q} included in the orientation output 628. In some aspects, the orientation uncertainty information \hat{Λ}_{θ} included in the orientation engine output 628 can be the same as or similar to an orientation uncertainty included in the uncertainty û generated by the pose estimation neural network 520 of FIG. 5 to correspond to the learned network measurements (e.g., the refined estimates 525).

The velocity estimation engine 640 can be used to generate a velocity output 658 that includes a velocity vector \hat{v} indicative of velocity information that may be the same as or similar to the velocity vector \hat{v} included in the learned network measurement (e.g., the refined estimates 525) of FIG. 5. The velocity output 658 generated by the velocity estimation engine 640 can further include velocity uncertainty information Av corresponding to the velocity vector \hat{v}. For example, the velocity uncertainty information \hat{Λ}ᵥ can be indicative of a confidence or covariance term associated with the velocity vector \hat{v} generated by the velocity estimation engine 640 and included in the velocity output 658 of FIG. 6. In some cases, the velocity uncertainty information \hat{Λ}ᵥ can be a covariance matrix corresponding to the velocity vector \hat{v} included in the velocity output 658. In some aspects, the velocity uncertainty information \hat{Λ}ᵥ included in the velocity engine output 658 can be the same as or similar to a velocity uncertainty included in the uncertainty û generated by the pose estimation neural network 520 of FIG. 5 to correspond to the learned network measurements (e.g., the refined estimates 525).

In some aspects, the position estimation engine 670 can be used to generate a position output 688 that includes position information \hat{p}, which can be the same as or similar to the position \hat{p}included in the learned network measurement (e.g., the refined estimates 525) of FIG. 5. The position output 688 generated by the position estimation engine 670 can further include position uncertainty information Ap corresponding to the position information p. For example, the position uncertainty information \hat{Λ}ᵥ can be indicative of a confidence or covariance term associated with the position information p generated by the position estimation engine 670 and included in the position output 688 of FIG. 6. In some cases, the position uncertainty information \hat{Λ}\hat{p} can be a covariance matrix corresponding to the position information \hat{p} included in the position output 688. In some aspects, the position uncertainty information \hat{Λ}p included in the position engine output 688 can be the same as or similar to a position uncertainty included in the uncertainty û generated by the pose estimation neural network 520 of FIG. 5 to correspond to the learned network measurements (e.g., the refined estimates 525).

In one illustrative example, the systems and techniques can implement a learned 3D relative rotation measurement (e.g., learned orientation change measurement and/or absolute orientation prediction) using a quaternion representation of orientation and/or rotation. For example, the orientation estimates \hat{R} of FIG. 5 can be generated as quaternion representations (e.g., such as the orientation quaternion \hat{q} generated by the orientation estimation engine 610 of FIG. 6 and included in the orientation prediction output 628).

Quaternions are four-dimensional (4D) vector representations of 3D rotations, and can be used to perform orientation estimation. For example, the orientation estimation engine 610 can be configured to generate the orientation output 628 to include a 4D orientation quaternion \hat{q} to represent a 3D orientation along the roll, pitch, and yaw axes (e.g., angular orientation or rotation about x, y, z positional axes).

In some aspects, a quaternion can be represented using the form q=r+(x·i)+(y·j)+(z·k), where r represents the real-valued portion of the quaternion and the terms x, y, and z represent the imaginary-valued portion of the quaternion (e.g., similar to the representation of complex numbers). In one illustrative example, a unit quaternion with norm 1 (e.g., a magnitude equal to 1) can be used to represent a rotation operator, with the operation defined by quaternion multiplication: p′=qpq⁻¹. Here, the term q⁻¹=r−(x·i)−(y·j)−(z·k) represents the conjugate (e.g., inverse) quaternion. A plurality of different quaternions can be unit quaternions with norm 1 (e.g., with respective magnitudes each equal to 1). Each different unit quaternion can correspond to a unique rotation in 3D space.

In one illustrative example, the machine learning architecture 600 of FIG. 6 can be a Transformer or Transformer-based machine learning architecture. For example, the orientation estimation engine 610 can be implemented using one or more Transformers or Transformer layers, the velocity estimation engine 640 can be implemented using one or more Transformers or Transformer layers, and the position estimation engine 670 can be implemented using one or more Transformers or Transformer layers. In some aspects, the orientation estimation engine 610, the velocity estimation engine 640, and the position estimation engine 670 can utilize the same Transformer or Transformer-based machine learning architecture comprising a Transformer encoder and a Transformer decoder.

For example, the orientation estimation engine 610 can include an orientation encoder 622 implemented using a Transformer encoder machine learning architecture, and an orientation decoder 626 implemented using a Transformer decoder machine learning architecture. The velocity estimation engine 640 can include a velocity encoder 652 implemented using a Transformer encoder machine learning architecture, and a velocity decoder 656 implemented using a Transformer decoder machine learning architecture. The position estimation engine 670 can include a position encoder 682 implemented using a Transformer encoder machine learning architecture, and a position decoder 686 implemented using a Transformer decoder machine learning architecture.

In some aspects, the orientation estimation engine 610 can receive a first input 612 comprising IMU data (w, a) (e.g., indicative of angular velocity and linear acceleration information determined by an IMU, such as the IMU 504 of FIG. 5, 454 of FIG. 4B, 404 of FIG. 4A, etc.). In some examples, the first input 612 can also be referred to as IMU data 612 or inertial information 612. The orientation estimation engine 610 can obtain the IMU data 612 from an IMU (e.g., IMU 504 of FIG. 5), can obtain the IMU data 612 from an IMU buffer (e.g., IMU buffer 508 of FIG. 5), or various combinations thereof.

In some aspects, the IMU data 612 can be received as input by the orientation estimation engine 610 and can be processed by the orientation encoder 622. For example, the IMU data 612 can be provided to one or more linear embedding layers of the orientation estimation engine 610 to generate corresponding linear embeddings for the IMU data 612. The linear embeddings of the input IMU features 612 (e.g., IMU data (ω, α)) can be provided to an element-wise addition operation to combine the linear embeddings of the IMU features 612 with corresponding positional encodings or position embeddings, indicative of information associated with the position(s) of each linear embedding token or feature in the sequence of linear embedding tokens or features generated for the IMU inputs (ω, α) 612. In some aspects, rotary position encoding and/or rotary position embedding can be used instead of the element-wise addition operation, to provide as input to the orientation encoder 622 the IMU features 612 combined with relative position information for the various features.

The IMU inputs (ω, α) 612 (e.g., the linear embeddings with position embedding information) can be processed by the orientation encoder 622, and the output of the orientation encoder 622 can be provided as input to the orientation decoder 626 that is also included in the orientation estimation engine 610.

The orientation estimation engine 610 can receive a second input 614, comprising estimated orientation (e.g., an initial estimated orientation quaternion q₀). In some aspects, the second input 614 can be based on the orientation information \hat{R}ᵢ determined as an initial prediction by the EKF 540 of FIG. 5 (e.g., the initial predicted orientation \hat{R}ᵢ generated based on propagation of the current IMU data by the EKF 540 of FIG. 5). Based on the orientation estimation engine 610 of FIG. 6 being configured to use quaternion representations of 3D orientation information as a 4D quaternion vector, the predicted orientation input q₀ 614 to the orientation estimation engine 610 can be a quaternion representation of or corresponding to the initial predicted orientation Ri determined by the EKF 540 of FIG. 5.

In one illustrative example, the predicted orientation input q₀ 614 to the orientation estimation engine 610 can be obtained from the IMU buffer 508 of FIG. 5, and may include orientation history information and the EKF 540 predicted orientation \hat{R}ᵢ determined as the projection or propagation to the next time step. For example, the second input 614 to the orientation estimation engine 610 can be the orientation information q₀|q, including the EKF-predicted orientation q₀ and the history orientation information \hat{q} obtained from the IMU buffer 508 of FIG. 5.

The orientation input 614 to the orientation estimation engine 610 can be processed using the orientation decoder 626, which can be a Transformer machine learning decoder, as noted above. In some cases, the orientation input 614 can be processed by a linear embedding layer of the orientation estimation engine 610, and provided to an element-wise addition operation to combine the linear embeddings of the orientation input 614 features with corresponding positional embeddings or position information. In some aspects, the orientation input 614 can be combined with relative position information of the input features, based on using rotary position embedding and/or rotary position encoding (e.g., rather than the element-wise addition operation). From the linear embedding layer associated with the orientation input 614, the EKF-predicted orientation information q₀ and orientation history information q can be processed using one or more multi-head attention layers of the Transformer decoder architecture of the orientation decoder 626, followed by addition and normalization layers.

The Transformer architecture of the orientation decoder 626 can include a second set of multi-head attention layers, which can receive the output of the addition and normalization layers used to process the EKF and history orientation input information 614. The second set of multi-head attention layers of the Transformer-based orientation decoder 626 can additionally receive as input the output of the Transformer-based orientation encoder 622 (e.g., the orientation encoder 622 output generated based on using the orientation encoder 622 to process the input IMU data 612).

The subsequent layers of the Transformer-based orientation decoder 626 can process the information representative of the IMU data 612 from the orientation encoder 622 and the EKF orientation prediction 614, to thereby generate as output from the orientation decoder 626 an intermediate Transformer representation of a refined orientation prediction. For example, the orientation decoder 626 can use the encoded representation of the IMU data 612 generated by the orientation encoder 622 to refine the initial EKF predicted orientation q₀ 614.

The output of the Transformer-based orientation decoder 626 may be an intermediate Transformer representation and/or may utilize an intermediate Transformer output dimension. In some aspects, the orientation estimation engine 610 can include a first linear output layer on a first output path of the orientation decoder 626, and a second linear output layer on a second output path of the orientation decoder 626. The first and second linear output layers can be the same as one another, and both the first output path and the second output path of the orientation decoder 626 can receive the same intermediate representation of the refined orientation prediction that is generated by the Transformer-based orientation decoder 626.

In one illustrative example, the first and second linear output layers (e.g., corresponding to the first and second output paths from the orientation decoder 626, respectively) can be used to generate the orientation output 628 including the unit norm quaternion \hat{q} and the corresponding orientation uncertainty information \tilde{Λ}_{θ}.

In some aspects, the first output path (e.g., the left output path in FIG. 6) of the orientation decoder 626 can include a normalization layer 627, configured to receive the 4D quaternion representation generated by the first linear output layer from the intermediate dimension output of the orientation decoder 626. The normalization layer 627 can normalize the 4D quaternion vector from the first linear output layer to generate the unit quaternion \hat{q} with norm (e.g., magnitude) equal to 1. The unit quaternion \hat{q} from the normalization layer 627 on the first output path of the orientation decoder 626 can be the same as the unit quaternion output \hat{q} 628 of the orientation estimation engine 610.

In some aspects, the normalization layer 627 associated with the orientation decoder 626 and generating the predicted quaternion orientation \hat{q} 628 can be used to provide a unit norm constraint on the output of the orientation decoder 626. For example, as noted above, a unit quaternion with norm 1 (e.g., magnitude equal to one) may be used to represent orientation information. The normalization layer 627 can be added after the fully-connected linear output layer on the output of the orientation decoder 626, to validate the output. For example, a tanh (.) or other activation used in many regression models for a target variable between [1,1] may be insufficient for generating the predicted orientation output 628 of the orientation estimation engine 610 to be a unit quaternion \hat{q}.

The second output path (e.g., the right output path in FIG. 6) of the orientation decoder 626 can include an exponential layer configured to generate a predicted confidence or covariance term for the unit quaternion output 628 prediction \hat{q}. The exponential layer on the second output path can be used as an exponential activation for predicting the covariance matrix \hat{Λ}_{θ} of the unit quaternion output \hat{q} 628, where the exponential activation forces the covariance matrix to be positive-valued.

The orientation estimation engine 610 (e.g., including the orientation encoder 622 and the orientation decoder 626) can be trained based on a regularization loss 634 and a reconstruction loss 638. For example, the regularization loss 634 can be determined as D_{KL}(P_{q}∥P_{q}), and may be evaluated between the predicted unit norm quaternion output \hat{q} 628 generated by the orientation decoder 626 and orientation estimation engine 610, and a prior distribution 632 indicative of ground truth orientation and uncertainty information q, ∇_{θ}. In some aspects, the regularization loss 634 can be based on a comparison between p_{q} (e.g., the distribution of the quaternion prediction \hat{q}) and p_{q} (e.g., the ground-truth quaternion distribution).

The reconstruction loss 638 can be calculated between ground truth angular velocity information 636 ω and the derivative 635 of the predicted orientation quaternion output \hat{q} 628 generated by the orientation decoder 626 and orientation estimation engine 610 (e.g., based on angular velocity being equal to a derivative of orientation with respect to time). For example, the reconstruction loss 638 can correspond to [symbol] (ω-ω, Λ_{ω}), calculated between the ground truth angular velocity 636 ω and the derivative 635 of the predicted orientation quaternion output \hat{q} 628.

In some examples, such as in Variational Auto-Encoder (VAE)-based techniques, uncertainty information can be determined based on parameterizing the uncertainty of a state based on decoupling the state to a mean variable and a zero-mean Gaussian noise term x=μ+n. In such approaches, the covariance of the noise variable n can be calculated and used to represent the uncertainty in the prediction.

In some aspects, determining uncertainty as the covariance of a Gaussian noise term or other noise variable may not be compatible with characterizing quaternion uncertainty (e.g., such as the quaternion uncertainty \hat{Λ}_{θ} included in the orientation output prediction 628 corresponding to the predicted unit quaternion orientation \hat{q} generated by the orientation estimation engine 610). For example, because quaternion rotation is defined by Lie algebra instead of Euclidean summation, techniques for uncertainty characterization based on noise covariance may not be applicable to characterizing the quaternion uncertainty.

In one illustrative example, the systems and techniques can configure the orientation estimation engine 610 to determine the quaternion uncertainty \hat{Λ}_{θ} of the predicted orientation output 628 based on parameterizing the uncertainty in SO(3) space instead of the Euclidean F(3) space. For example, the uncertainty for the predicted orientation quaternion (e.g., the uncertainty \hat{Λ}_{θ}) can be represented as an error term that is post chain multiplied to the predicted quaternion: q=qδq. The term δq represents a small deviation from the identity rotation q₁=[1 0 0 0], and may be approximated as

$$δ q \approx [ 1 , \frac{1}{2} {θ}_{x} , \frac{1}{2} {θ}_{y} , \frac{1}{2} {θ}_{z} ] .$$

In some aspects, the uncertainty for the predicted orientation quaternion (e.g., the uncertainty \hat{Λ}_{θ}) can be determined based on formulating the covariance prediction as a prediction of the 3-dimensional error term covariance of θₓ, θ_{y}, θ_{z}.

For example, in some cases, the regularization loss 634 can be represented as D_{KL} (P_{q}∥P_{q}), as noted above, corresponding to the form

$${D}_{KL} ( P ‖ Q ) = {E}_{p} [ log ( P / Q ) ] .$$

Taking q₀ as the identity unit quaternion, the quaternion qt can be represented as

$${q}_{t} = δ {q}_{t} = {[ \frac{1}{2} {δθ}_{t}^{T} 1 ]}^{T} .$$

Therefore, δθ=[2qᵢ, 2qⱼ, 2qₖ]=[δθₓ, δθ_{y}, δθ_{z}]. Taking μ=δθ for

$${( \begin{matrix}{q}_{t} \\ GT\end{matrix} )}^{inv} ⊗ ( \begin{matrix}{q}_{t} \\ pred\end{matrix} ) ,$$

then:
P=prediction error ˜ [symbol] (μₚ, Λₚ)
Q=desired error ˜ [symbol] (O, Λ_{Q})

$${Λ}_{x} = diag ( {{σ}_{x}}_{x}^{2} , {{σ}_{x}}_{y}^{2} , {{σ}_{x}}_{z}^{2} )$$

A multi-variate Gaussian can be given as:

$$P ( \vec{θ} \vert {\vec{μ}}_{p} , {Λ}_{p} ) = \frac{exp ( - \frac{1}{2} {\sum }_{i ϵ x , y , z} {{σ}_{{p}_{i}}^{- 2} ( {θ}_{i} - {μ}_{{p}_{i}} )}^{2} )}{{( 2 π )}^{3 / 2} ( {σ}_{{p}_{x}} \cdot {σ}_{{p}_{y}} \cdot {σ}_{{p}_{z}} )}$$

$${D}_{KL} ( P ‖ Q ) = {E}_{p} [ log ( P / Q ) ]$$

can be rewritten as:

$${D}_{KL} ( P ‖ Q ) = log ( \begin{matrix}π \\ i\end{matrix} \frac{{σ}_{{q}_{i}}}{{σ}_{{p}_{i}}} ) + \frac{1}{2} {E}_{p} [ {\sum }_{i} {σ}_{{q}_{i}}^{- 2} {θ}_{i}^{2} - {\sum }_{i} {σ}_{{p}_{i}}^{- 2} ( {θ}_{i}^{2} + {μ}_{{p}_{i}}^{2} - 2 {θ}_{i} {μ}_{{p}_{i}} ) ] = log ( \begin{matrix}π \\ i\end{matrix} \frac{{σ}_{{q}_{i}}}{{σ}_{{p}_{i}}} ) + \frac{1}{2} {\sum }_{i} {σ}_{{q}_{i}}^{- 2} ( {σ}_{{p}_{i}}^{2} + {μ}_{{p}_{i}}^{2} ) - \frac{3}{2} , where i ϵ \{ x , y , z \}$$

The velocity estimation engine 640 can be implemented as a Transformer machine learning block, the same as or similar to that associated with the orientation estimation engine 610 and/or the position estimation engine 670, as noted above. The velocity estimation engine 640 can include a velocity encoder 652 and a velocity decoder 656, which can be a Transformer-based encoder and a Transformer-based decoder, respectively. The velocity encoder 652 can be the same as or similar to the orientation encoder 622, and the velocity decoder 656 can be the same as or similar to the orientation decoder 626.

The velocity estimation engine 640 can receive a first input 641 including or indicative of acceleration information a, accelerometer bias information bₐ, and a gravitational constant go. In some aspects, the acceleration information a included in the first input 641 to the velocity estimation engine 640 can be the same as the acceleration information a included in the first input 612 to the orientation estimation engine 610. For example, the first input 612 to the orientation estimation engine 610 and the first input 641 to the velocity estimation engine 640 can include the same acceleration information a, obtained from an IMU (e.g., IMU 504 of FIG. 5, etc.) and/or obtained from an IMU buffer associated with an IMU (e.g., IMU buffer 508 of FIG. 5, etc.). The accelerometer bias information bₐ included in the first input 641 to the velocity estimation engine 640 can be the same as or similar to the accelerometer bias information included in the EKF state 545 of FIG. 5.

The velocity estimation engine 640 can use the first input 641 (e.g., the information a, bₐ, g₀) and the predicted unit norm orientation quaternion \hat{q} (e.g., generated as output 628 by the orientation estimation engine 610) to generate the velocity encoder input 642. For example, the velocity encoder input 642 can be equal to

$${a}^{\hat{q}} - {g}_{o} , {b}_{a}^{\hat{q}} ,$$

where the term a^{q} represents the acceleration information a (e.g., from the first input 641 and/or IMU or IMU buffer) anchored by the predicted unit norm orientation quaternion \hat{q} included in the output 628 obtained from the orientation estimation engine 610. The anchored acceleration information a^{q} can be converted to linear acceleration information a^{q}-gₒ based on subtracting the gravity constant gₒ from the anchored acceleration information a^{q}. In one illustrative example, the velocity encoder input 642 can include the linear anchored acceleration information a^{q}-gₒ, and can include

$${b}_{a}^{\hat{q}} ,$$

which represents the accelerometer bias b₀ anchored with the predicted unit norm orientation quaternion \hat{q}.

The velocity encoder input 642 can be provided to an input linear embedding layer associated with the velocity encoder 652 to generate corresponding linear embeddings for the velocity encoder input 642,

$${a}^{\hat{q}} - {g}_{o} , {b}_{a}^{\hat{q}} .$$

The linear embeddings of the velocity encoder input 642 can be combined with position embedding information by an element-wise addition operation, and provided as the input vector to the velocity encoder 652. The velocity encoder 652 can be a Transformer-based encoder, and can process the linear embeddings of the velocity encoder input 642,

$${a}^{\hat{q}} - {g}_{o} , {b}_{a}^{\hat{q}} ,$$

to generate an encoded output corresponding to the linear acceleration information of the velocity encoder input 642.

The velocity decoder 656 can receive as input an initial velocity prediction 644 (e.g., v/v), corresponding to an initial prediction of velocity as determined by the EKF 540 of FIG. 5. For example, the initial EKF velocity prediction 644 (e.g., v₀|v) can be determined based on the EKF 540 performing propagation of the IMU data (ω, α) obtained from the IMU 504 of FIG. 5. The initial velocity prediction 644 can be provided to an input linear embedding layer associated with the velocity decoder 656, combined with position embedding information, and processed by the velocity decoder 656.

The velocity decoder 656 can obtain the encoded linear acceleration information (e.g., generated as the velocity encoder 652 output from processing the linear acceleration information 642) as an additional input for performing combined processing with the initial EKF-predicted velocity information 644.

In some aspects, the velocity decoder 656 can generate as output an intermediate representation (e.g., a representation using an intermediate Transformer output dimension) of a refined velocity prediction, where the velocity decoder 656 generates the refined velocity prediction based on the linear acceleration information 642 encoded by the velocity encoder 652, and based on the initial velocity prediction 644. For example, the refined velocity prediction can correspond to updating the initial velocity prediction 644 based on an integration of the linear acceleration information 642 (e.g., based on the integral of acceleration being change in velocity).

The output of the velocity decoder 656 can be provided to a first linear output layer on a first output branch (e.g., the left branch off the output of the velocity decoder 656 in FIG. 6) and can be provided to a second linear output layer on a second output branch (e.g., the right branch off the output of the velocity decoder 656 in FIG. 6). The first linear output layer on the first (e.g., left) output branch of the velocity decoder 656 can generate the predicted velocity vector v corresponding to the refinement of the initial EKF velocity prediction 644 based on the linear acceleration information 642. The predicted (e.g., refined) velocity vector v can be included in the velocity prediction output 658 generated by the velocity estimation engine 640.

The velocity prediction output 658 can include the refined velocity prediction \hat{v} and a corresponding predicted confidence or covariance term \hat{Λ}ᵥ determined for the refined velocity prediction v of the velocity estimation engine 640. For example, the predicted confidence or covariance term \hat{Λ}p can be generated as a covariance matrix, based on processing the output of the velocity decoder 656 with the second linear output layer of the second (e.g., right) output branch of the velocity decoder 656, followed by an exponential layer to force the velocity uncertainty \hat{Λ}p to be positive-valued.

The velocity prediction output 658 of the velocity estimation engine 640, and the orientation prediction output 628 of the orientation estimation engine 610, can be included in the learned network measurements (e.g., the refined estimates 525) of FIG. 5. For example, the unit norm refined orientation quaternion prediction \hat{q} (e.g., included in the orientation prediction output 628 of FIG. 6) and the refined velocity vector prediction v (e.g., included in the velocity prediction output 658 of FIG. 6) can both be included in the learned network measurements (e.g., the refined estimates 525) generated by the pose estimation neural network 520 of FIG. 5. The corresponding orientation uncertainty \hat{Λ}_{θ} from the orientation prediction output 628 and the velocity uncertainty \hat{Λ}ᵥ from the velocity prediction output 658 can both be included in the uncertainty information u also generated by the pose estimation neural network 520 of FIG. 5.

Training of the velocity estimation engine 640 can be similar to the training of the orientation estimation engine 610. For example, the velocity estimation engine 640 (e.g., including the velocity encoder 652 and the velocity decoder 656) can be trained based on a regularization loss 664 and a reconstruction loss 668. In one illustrative example, the velocity regularization loss 664 can be determined as D_{KL} (P_{θ}∥pᵥ), evaluated between po (e.g., the distribution of the predicted velocity \tilde{v}) and pᵥ (e.g., the distribution of the ground truth velocity information included in the prior distribution information 662). For example, the prior velocity distribution information 662 can be ground truth velocity and uncertainty information v, θᵥ. In some aspects, the velocity regularization loss 664 can be similar to the orientation regularization loss 634, and the velocity prior distribution or ground truth information 662 can be similar to the orientation prior distribution or ground truth information 632.

The velocity reconstruction loss 668 can be based on ground truth linear acceleration information 666 (e.g., a^{q}-gₒ) and a time derivative 665 of the predicted velocity vector \hat{v} generated by the velocity estimation engine 640 in the velocity prediction output 658. For example, the time derivative of velocity can correspond to acceleration, and the calculated time derivative 665 of the velocity prediction output \hat{v} 658 can be compared against ground truth linear acceleration information 666 (e.g., a^{q}-g₀) using the velocity reconstruction loss 668. For example, the velocity reconstruction loss 668 can be given as

$$𝒩 ( {a}^{q} - {g}_{0} - \frac{d \hat{v}}{dt} , {\hat{Λ}}_{{a}^{q}} ) .$$

The position estimation engine 670 can be implemented as a Transformer machine learning block, the same as or similar to that associated with the orientation estimation engine 610 and/or the velocity estimation engine 640, as noted above. The position estimation engine 670 can include a position encoder 682 and a position decoder 686, which can be a Transformer-based encoder and a Transformer-based decoder, respectively. The position encoder 682 can be the same as or similar to the orientation encoder 622 and/or the velocity encoder 652, and the position decoder 686 can be the same as or similar to the orientation decoder 626 and/or the velocity decoder 656.

The position estimation engine 670 can receive a first input 672 comprising the output of the linear embedding layer associated with the velocity encoder 652 of the velocity estimation engine 640. For example, the first input 672 provided to the position encoder 682 of the position estimation engine 670 can be the linear embeddings generated by the velocity estimation engine 640 for the anchored linearized acceleration information 642 described above.

At the input to the position encoder 682 of the position estimation engine 670, the first input 672 of the linear embeddings of the anchored linearized acceleration information 642 can be combined with the velocity prediction output v 658 generated by the velocity estimation engine 640, and an element-wise addition operation can be performed to add position embedding information.

The position encoder 682 can be a Transformer-based encoder, and can process the input comprising the linear embeddings 672 of the velocity encoder input

$$642 ( {a}^{\hat{q}} - {g}_{0} , {b}_{a}^{\hat{q}} )$$

and the velocity prediction output \hat{v} 658 to generate a corresponding encoded position output. The encoded position output generated by the position encoder 682 is based on acceleration information and velocity information, and can be used to update (e.g., refine) an initial position prediction 674 (e.g., based on velocity being the first derivative of position, and acceleration being the second derivative of position, etc.).

For example, the position decoder 686 can receive as input an initial position prediction 674 (e.g., p₀|p), corresponding to an initial prediction of position as determined by the EKF 540 of FIG. 5. For example, the initial EKF position prediction 674 (e.g., p₀|p) can be determined based on the EKF 540 performing propagation of the IMU data (ω, α) obtained from the IMU 504 of FIG. 5. The initial position prediction 674 can be provided to an input linear embedding layer associated with the position decoder 686, combined with position embedding information, and processed by the position decoder 686.

The position decoder 686 can obtain the encoded velocity and acceleration information generated as output by the position encoder 682. For example, the position decoder 686 can use the encoded velocity and acceleration information generated by the position encoder 682 as an additional input for performing combined processing with the initial EKF-predicted position information 674.

In some aspects, the position decoder 686 can generate as output an intermediate representation (e.g., a representation using an intermediate Transformer output dimension) of a refined position prediction, where the position decoder 686 generates the refined position prediction based on the encoded output of the position encoder 682 and the initial EKF position prediction 674.

For example, determining the refined position prediction by the position decoder 686 can correspond to updating (e.g., by the position decoder 686) the initial EKF position prediction 674, using one or more integration of the acceleration information

$${a}^{\hat{q}} - {g}_{0} , {b}_{a}^{\hat{q}}$$

and/or the velocity information v represented within the encoded output of the position encoder 682.

The output of the position decoder 686 can be provided to a first linear output layer on a first output branch (e.g., the left branch off the output of the position decoder 686 in FIG. 6) and can be provided to a second linear output layer on a second output branch (e.g., the right branch off the output of the position decoder 686 in FIG. 6). The first linear output layer on the first (e.g., left) output branch of the position decoder 686 can generate the predicted position information \hat{p} corresponding to the refinement of the initial EKF position prediction 674. The predicted (e.g., refined) position information p can be included in the position prediction output 688 generated by the position estimation engine 670.

The position prediction output 688 can include the refined position prediction p and a corresponding predicted confidence or covariance term \hat{Λ}\hat{p} determined for the refined position prediction \hat{p} of the position estimation engine 670. For example, the predicted confidence or covariance term \hat{Λ}ₚ can be generated as a covariance matrix, based on processing the output of the position decoder 686 with the second linear output layer of the second (e.g., right) output branch of the position decoder 686, followed by an exponential layer to force the position uncertainty \hat{Λ}ₚ to be positive-valued.

The position prediction output 688 of the position estimation engine 670, the velocity prediction output 658 of the velocity estimation engine 640, and the orientation prediction output 628 of the orientation estimation engine 610, can be included in the learned network measurements (e.g., the refined estimates 525) of FIG. 5. For example, the unit norm refined orientation quaternion prediction \hat{q} (e.g., included in the orientation prediction output 628 of FIG. 6), the refined velocity vector prediction v (e.g., included in the velocity prediction output 658 of FIG. 6), and the refined position prediction \hat{p} can each be included in the learned network measurements (e.g., the refined estimates 525) generated by the pose estimation neural network 520 of FIG. 5. The corresponding orientation uncertainty \hat{Λ}_{θ} from the orientation prediction output 628, the corresponding velocity uncertainty \hat{Λ}ᵥ from the velocity prediction output 658, and the corresponding position uncertainty Ay from the position prediction output 688 can each be included in the uncertainty information u also generated by the pose estimation neural network 520 of FIG. 5.

Training of the position estimation engine 670 can be similar to the training of the orientation estimation engine 610 and/or training the velocity estimation engine 640. For example, the position estimation engine 670 (e.g., including the position encoder 682 and the position decoder 686) can be trained based on a regularization loss 694 and a reconstruction loss 698. In one illustrative example, the position regularization loss 694 can be determined as D_{KL} (Pᵥ∥Pₚ), evaluated between pₚ (e.g., the distribution of the predicted position \hat{p}) and pₚ (e.g., the distribution of the ground truth position information included in the prior distribution information 692). For example, the prior position distribution information 692 can be ground truth position and uncertainty information p, Ap. In some aspects, the position regularization loss 694 can be similar to the orientation regularization loss 634 and/or the velocity regularization loss 664, and the position prior distribution or ground truth information 692 can be similar to the orientation prior distribution or ground truth information 632 and/or the velocity prior distribution or ground truth information 662.

The position reconstruction loss 698 can be based on ground truth velocity information v 696 and a time derivative 695 of the predicted position information p generated by the position estimation engine 670 in the position prediction output 688. For example, the time derivative of position can correspond to velocity, and the calculated time derivative 695 of the position prediction output \hat{p} 688 can be compared against ground truth velocity information v 696 using the position reconstruction loss 698. For example, the position reconstruction loss 698 can be given as

$$𝒩 ( v - \frac{d \hat{p}}{dt} , {\hat{Λ}}_{v} ) .$$

In some aspects, an initial prediction of the EKF 540 of FIG. 5 (e.g., initial prediction information corresponding to the EKF state vector 545 and the EKF 540 of FIG. 5) can be used to provide the respective inputs to each of the orientation decoder 626, the velocity decoder 6546, and the position decoder 686 of FIG. 6. For example, the orientation decoder 626 can utilize the input 614 corresponding to an EKF-predicted initial quaternion orientation q₀, which may be determined by the EKF 540 based on propagation of the IMU 504 data of FIG. 5. The velocity decoder 656 can utilize the input 644 corresponding to an EKF-predicted initial velocity vector v₀, which may be determined by the EKF 540 based on propagation of the IMU 504 data of FIG. 5. The position decoder 686 can utilize the input 674 corresponding to an EKF-predicted initial position p₀, which may be determined by the EKF 540 also based on the propagation of the IMU 504 data of FIG. 5.

In some aspects, the pose estimation or pose refinement machine learning network 600 of FIG. 6 can be trained end-to-end. For example, the orientation estimation engine 610, the velocity estimation engine 640, and the position estimation engine 670 can be trained together, using various end-to-end training techniques. In some aspects, end-to-end training can be performed based on minimizing a combined or end-to-end regularization loss (e.g., corresponding to the combination of the orientation regularization loss 634, the velocity regularization loss 664, and the position regularization loss 694), and minimizing a combined or end-to-end reconstruction loss (e.g., corresponding to the combination of the orientation reconstruction loss 638, the velocity reconstruction loss 668, and the position reconstruction loss 698).

In some examples, the orientation estimation engine 610 can be trained separately, based on minimizing the orientation regularization loss 634 and the orientation reconstruction loss 638. In some examples, the velocity estimation engine 640 can be trained separately, based on minimizing the velocity regularization loss 664 and the velocity reconstruction loss 668. In some examples, the position estimation engine 670 can be trained separately, based on minimizing the position regularization loss 694 and the position reconstruction loss 698. Performing separate training for the orientation estimation engine 610, the velocity estimation engine 640, and the position estimation engine 670 can allow each resulting trained engine to be deployed separately and/or as a standalone trained machine learning network. In some aspects, the orientation estimation engine 610 can be trained separately, and the velocity estimation engine 640 and the position estimation engine 670 can be trained together or in combination.

As noted above, 6DOF tracking and/or 6DOF pose estimation can be performed based on using a unit quaternion orientation parameterization, where the unit quaternion is a unit 4D vector that represents a rotation operation via quaternion multiplication. The representation of a rotation operation by a unit quaternion can be similar to the use of a 3×3 rotation matrix applied to rotate a 3D vector. In some cases, the use of the unit quaternion representation for orientation parameterization may be associated with double covering of the SO(3) space. The SO(3) space represents the space of all possible rotations around the origin of 3D Euclidean space. When the SO(3) space is double covered by the unit quaternion orientation parameterization, the two quaternions given as \hat{q} and −q represent the same rotation. The antipodal problem associated with the unit quaternion orientation parameterization double covering the SO(3) space can be associated with performance degradation when learning quaternion regressor machine learning models. For example, the quaternion regressor machine learning model may be unaware of the antipodal symmetry and/or the double covering between \hat{q} and −q, as the quaternion regressor machine learning model is trained to predict 4D real values (e.g., real-valued 4D quaternions). In some examples, in quaternion sequence regression tasks, temporal continuity can heavily favor sign continuation between the orientation quaternions from earlier time slots. However, when significant rotation occurs over a short duration or between consecutive or adjacent time slots (e.g., rapid or large change in orientation along none or more axes), a sign change for the unit quaternion orientation parameterization can be unavoidable. In these examples, existing techniques for quaternion regressor model predictions can degrade, as the quaternion regressor model is forced to operate in the negative sign regime of the unit quaternion orientation parameterization, which is under-trained. In some cases, the quaternion regressor model can be trained and/or implemented based on always forcing a positive sign (e.g., positive-valued) orientation quaternion, although such approaches can also be associated with breaking the continuity of the quaternion integration function.

For example, a unit quaternion with norm (e.g., magnitude) equal to one can represent a rotation operator, with the rotation operation given by quaternion multiplication according to: p′=qpq⁻¹. Here, the term q⁻¹=r−(x·i)−(y·j)−(z·k) represents the conjugate (e.g., inverse) quaternion. A plurality of different quaternions can be unit quaternions with norm 1 (e.g., with respective magnitudes each equal to 1). Each different unit quaternion can correspond to a unique rotation in 3D space.

Based on the quaternion representation of a rotation operation as p′=qpq⁻¹, the sign of the quaternion \hat{q} (e.g., a positive signed quaternion \hat{q} or a negative signed quaternion-q) does not change the rotation output, and the SO(3) space is double covered based on (+q) \hat{p} (+q)−1 and (−q) \hat{p} (−q)−1 representing the same rotation operation p′ (e.g., (+q) \hat{p} (+q)−1=(−q) \hat{p} (−q)−1=p′).

To predict a subsequent q, based on the orientation quaternion history state information q_{1:t-1} (e.g., to predict the orientation quaternion at time t, qₜ, based on the history state of the orientation quaternion between times 1 and 1-1), the qₜ generated as the output prediction may likely be a smooth extrapolation from the history state q_{1:t-1}. However, as noted above, in the orientation regression problem associated with performing 6DOF pose tracking and/or estimation a 6DOF pose, the ground truth orientation quaternion may take an arbitrary sign, which can correspond to discontinuity caused in the predictor.

In some aspects, the systems and techniques can implement the learned orientation measurement (e.g., the learned orientation measurement \hat{R} of the learned network measurements (e.g., the refined estimates 525) generated by the pose estimation neural network 520 of FIG. 5, the refined orientation quaternion prediction \hat{q} included in the orientation prediction output 628 determined using the orientation estimation engine 610 of FIG. 6, etc.) based on a random binomial sign modulated self-supervision loss for decoder self-attention with unit quaternion input(s). For example, the pose estimation neural network 520 of FIG. 5, the pose estimation Transformer-based machine learning architecture 6t00 of FIG. 6, and/or the orientation estimation engine 610 of FIG. 6, can be trained using a quaternion symmetric loss

$${l}_{θ}^{sym}$$

to introduce a random binomial sign modulated self-supervision loss for decoder self-attention with unit quaternion input(s):

$${l}_{θ}^{sym} ( {\hat{q}}_{1 : t} , {q}_{1 : t} \vert {q}_{0 : t - 1} , {a}_{0 : t - 1} , {ω}_{0 : t - 1} ) = {l}_{θ}^{quat} ( {\hat{q}}_{1 : t} , {q}_{1 : t} \vert {q}_{0 : t - 1} , {a}_{0 : t - 1} , {ω}_{0 : t - 1} ) + {l}_{θ}^{quat} ( {\hat{q}}_{1 : t} , {q}_{1 : t} \vert {s}_{0 : t - 1} \cdot {q}_{0 : t - 1} , {a}_{0 : t - 1} , {ω}_{0 : t - 1} )$$

The value of

$${l}_{θ}^{quat}$$

represents the difference of two unit quaternions in SO(3) space as 1− [symbol] (q₁, q₂ [symbol] ². The expression q_{0:t-1}, α_{0:t-z}, W_{0:t-1} corresponds to the history state quaternion input to the Transformer decoder (e.g., the quaternion input 614 to the Transformer-based orientation decoder 626 of the orientation estimation engine 610 of FIG. 6), and the history state accelerometer and gyroscope IMU measurement inputs to the Transformer encoder (e.g., the IMU inputs 612 (ω, α) to the Transformer-based orientation encoder 622 of the orientation estimation engine 610 of FIG. 6).

In one illustrative example, the IMU buffer 508 of FIG. 5 can be used to store history state information for the orientation quaternion \hat{q} (e.g., such as the history state information q_{0:t-1}, corresponding to the orientation quaternion state at each previous time step from 0 to 1-1), history state information for the IMU accelerometer acceleration information a (e.g., such as the history state information do: t-1, corresponding to the acceleration measured by the IMU at each previous time step from 0 to 1-1), and angular velocity or rotation state information for the IMU gyroscope information ω (e.g., such as the history state information w_{0:t-1}, corresponding to the angular velocity or rotation measured by the IMU at each previous time step from 0 to t-1).

The term So: t-1 represents the binomial sign flip self-supervision, used to enforce the antipodal sign symmetry during learning for the orientation estimation engine 610 (e.g., used to enforce the antipodal sign symmetry during learning for the orientation encoder 622 and orientation decoder 626 of the orientation estimation engine 610 of FIG. 6). Based on the use of the binomial sign flip self-supervision S_{0:t-1}, at test or inference time, the trained orientation estimation engine 610 is equally trained independent of the quaternion sign history that is observed, and can better generalize to positive and negative values of quaternion inputs (e.g., can better discriminate between \hat{q} and −q antipodal quaternion orientation inputs 614 to the Transformer-based orientation decoder 626, etc.).

In one illustrative example, the random binomial sign modulated self-supervision loss for decoder self-attention with unit quaternion input(s) (e.g., the term So: t-1 representing the binomial sign flip self-supervision) can be implemented in the orientation regularization loss 634 of FIG. 6. For example, the orientation estimation engine 610 can be trained based on the regularization loss 634 (e.g., D_{KL} (P_{q}∥P_{q})), where the regularization loss 634 includes the quaternion symmetric loss

$${l}_{θ}^{sym} ( {\hat{q}}_{1 : t} , {q}_{1 : t} \vert {q}_{0 : t - 1} , {a}_{0 : t - 1} , {ω}_{0 : t - 1} )$$

given above, and/or where the regularization loss 634 includes the random bit term So: t-1 representing the binomial sign flip self-supervision. In some aspects, minimizing a global loss function (e.g., associated with end-to-end training for a machine learning architecture including the orientation estimation engine 610 of FIG. 6, such as end-to-end training of the machine learning architecture 600 of FIG. 6) and/or minimizing the regularization loss 634 associated with the orientation estimation engine 610 can correspond to the orientation estimation engine 610 learning to achieve the minimization with the presence of the random sign bit flips on the quaternion input 614 value, and the orientation estimation engine 610 learns to generalize and/or discriminate across the antipodal symmetry for the unit quaternions \hat{q} and −q.

In some aspects, the antipodal loss can be augmented with an IMU body frame equivariance loss, based on:

$${q}_{G ← {L}^{′}}^{*} ( 0 ) {q}_{G ← {L}^{′}} ( t ) = {q}_{{L}^{′} ← L} ⊗ {q}_{G ← L}^{*} ( 0 ) ⊗ {q}_{G ← L} ( t ) ⊗ {q}_{{L}^{′} ← L}^{*}$$

$$and$$

$${q}_{a}^{{L}^{′}} = {q}_{{L}^{′} ← L} ⊗ {q}_{a}^{L} ⊗ {q}_{{L}^{′} ← L}^{*} , {q}_{ω}^{{L}^{′}} = {q}_{{L}^{′} ← L} ⊗ {q}_{ω}^{L} ⊗ {q}_{{L}^{′} ← L}^{*}$$

For example, the IMU body frame equivariance loss

$${l}_{θ}^{equiv}$$

can be determined as:

$${l}_{θ}^{equiv} ( {\hat{q}}_{1 : t} , {q}_{1 : t} \vert {q}_{0 : t - 1} , {a}_{0 : t - 1} , {ω}_{0 : t - 1} ) = {l}_{θ}^{quat} ( {\hat{q}}_{1 : t}^{L} , {q}_{1 : t}^{L} \vert {q}_{0 : t - 1}^{L} , {a}_{0 : t - 1}^{L} , {ω}_{0 : t - 1}^{L} ) + {l}_{θ}^{quat} ( {\hat{q}}_{1 : t}^{{L}^{′}} , {q}_{1 : t}^{{L}^{′}} \vert {s}_{0 : t - 1} \cdot {q}_{0 : t - 1}^{{L}^{′}} , {a}_{0 : t - 1}^{{L}^{′}} , {ω}_{0 : t - 1}^{{L}^{′}} )$$

The change of body frame for the IMU is represented as q_{L′-L}, and may be uniformly sampled and transformed from R_{α}·R_{γ} with a˜U(−π, π) and γ˜U(−π, π). In some aspects, the use of the IMU body frame equivariance loss

$${l}_{θ}^{equiv}$$

for training the orientation estimation engine 610 of FIG. 6 can improve performance over various device tilt angles. The IMU body frame equivariance loss

$${l}_{θ}^{equiv}$$

can be used in combination with the quaternion symmetric loss

$${l}_{θ}^{sym}$$

and/or the orientation regularization loss 634 for training of the orientation estimation engine 610 and/or the Transformer-based machine learning architecture 600 of FIG. 6.

In one illustrative example, the example architecture of the orientation estimation engine 610 can be used to directly predict (e.g., as the prediction output 628 from the orientation decoder 626) the orientation quaternion \hat{q}.

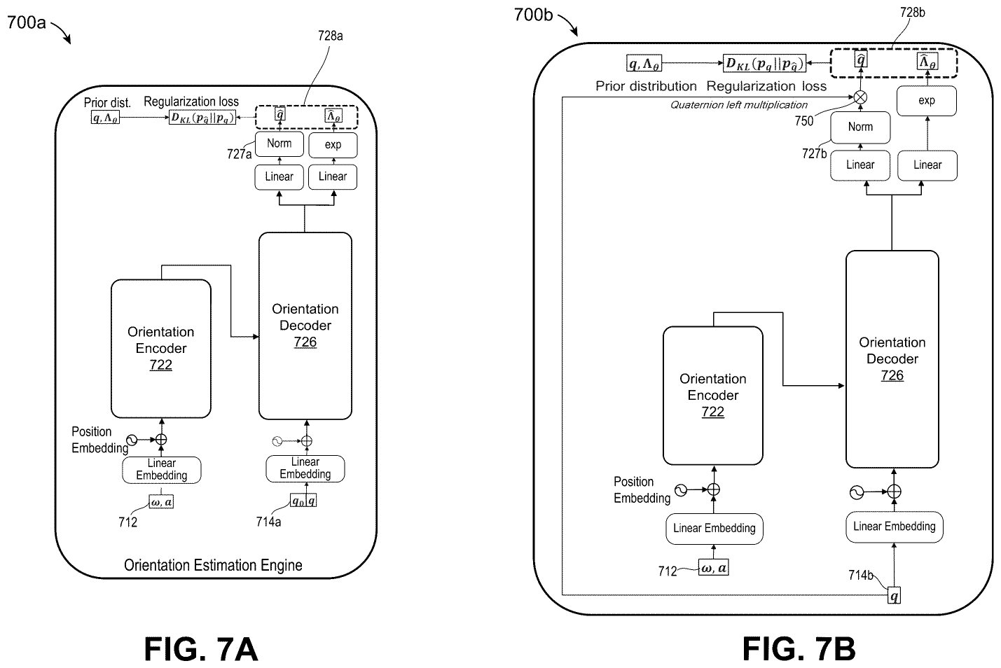

For example, FIG. 7A is a diagram depicting an orientation estimation engine 700a that can be the same as the orientation estimation engine 610 of FIG. 6. In some aspects, the first input 712 and the second input 714a of FIG. 7A can be the same as the first input 612 and the second input 614, respectively, of FIG. 6. The orientation encoder 722 and the orientation decoder 726 of FIG. 7A can be the same as or the orientation encoder 622 and the orientation decoder 626, respectively, of FIG. 6. The normalization layer 727a of FIG. 7A can be the same as the normalization layer 627 of FIG. 6. The orientation prediction output 728a of FIG. 7A can be the same as the orientation prediction output 628 of FIG. 6, etc.

In some aspects, the systems and techniques can implement an orientation estimation engine Transformer-based machine learning architecture that is configured to directly predict an error quaternion that can be applied to the orientation quaternion. For example, FIG. 7B is a diagram depicting an example architecture of an orientation estimation engine 700b that can be used to directly predict an error quaternion, and to apply the predicted error quaternion to the orientation quaternion.

In one illustrative example, the orientation estimation engine 700b of FIG. 7B can include components the same as or similar to those of the orientation estimation engine 700a of FIG. 7A and/or the orientation estimation engine 610 of FIG. 6. For example, the orientation estimation engine 700b of FIG. 7B can utilize the same first input 712 as the orientation estimation engine 700a of FIG. 7A, can include the same orientation encoder 722 and orientation decoder 726 as the orientation estimation engine 700a of FIG. 7A, etc.

In some aspects, the orientation estimation engine 700b of FIG. 7B can be configured to implement one or more residual connections for quaternion processing. For example, the orientation estimation engine 700b can include a quaternion residual connection layer 750, provided after the output of the normalization layer 727b on the output path of the orientation decoder 726. In one illustrative example, the quaternion residual connection layer 750 included in the orientation estimation engine 700b can be configured to implement a quaternion left multiplication operation for generating the quaternion information \hat{q} included in the orientation prediction output 728b. For example, the quaternion residual connection layer 750 can be used to implement a quaternion left multiplication operation associated with the quaternion prediction output 728b of the orientation estimation engine 700b of FIG. 7B, instead of the Euclidean summation operation implemented for the orientation estimation engine 700a of FIG. 7A that does not include a quaternion residual connection layer.

For example, the input 714b can be the EKF initial prediction of the orientation quaternion \hat{q} for the current time step 1. The input 714b can be the same as or similar to the EKF initial prediction of the orientation quaternion that is included in the input 714a of FIG. 7A and/or that is included in the input 614 of FIG. 6. In some aspects, the EKF initial quaternion prediction \hat{q} 714b of FIG. 7B can be the same as the initial quaternion orientation prediction determined by the EKF 540 of FIG. 5 (e.g., the EKF initial quaternion prediction \hat{q} 714b of FIG. 7B can be the same as the initial prediction R, determined by the EKF 540 of FIG. 5).

Rather than using the Transformer-based orientation decoder 726 to predict true or full orientation quaternions directly (e.g., such as in FIG. 7A, where the orientation decoder 726 output is processed by the fully-connected linear layers and the normalization layer 727a to directly generate the predicted orientation quaternion \hat{q} 728a), the orientation estimation engine 700b of FIG. 7B can configure and use the orientation decoder 726 to predict an error quaternion term as the output from the normalization layer 727b.

In one illustrative example, using the orientation decoder 726 to directly predict an error quaternion term as output can correspond to predict an error term or refinement term that can be applied to the initial EKF quaternion prediction \hat{q} 714b to generate the updated or refined orientation quaternion \hat{q} for the prediction output 728b of the orientation estimation engine 700b. For example, the output of the normalization layer 727b can be the error quaternion predicted by the orientation decoder 726. The error quaternion can then be provided from the output of the normalization layer 727b to the input of the quaternion residual connection layer 750.

The quaternion residual connection layer 750 can be configured to implement the quaternion left multiplication operation between the quaternion error prediction (e.g., from the orientation decoder 726) and the initial EKF quaternion prediction \hat{q} 714b, to thereby generate as output the refined orientation quaternion prediction \hat{q} included in the prediction output 728b of the orientation estimation engine 700b of FIG. 7B. In some aspects, the quaternion left multiplication operation associated with the quaternion residual connection layer 750, and used to apply the predicted error quaternion to the initial EKF quaternion 714b, can guarantee that the resulting output orientation quaternion \hat{q} 728b is a valid quaternion. In some aspects, the orientation estimation engine architecture 700b of FIG. 7B can be used to implement more efficient training, for example based on isolating the Transformer output from the orientation decoder 726 to become a pure error correction term, which can reduce the chance of network overfitting and may speed up the training process for the orientation estimation engine 700b and/or the orientation encoder 722 and orientation decoder 726.

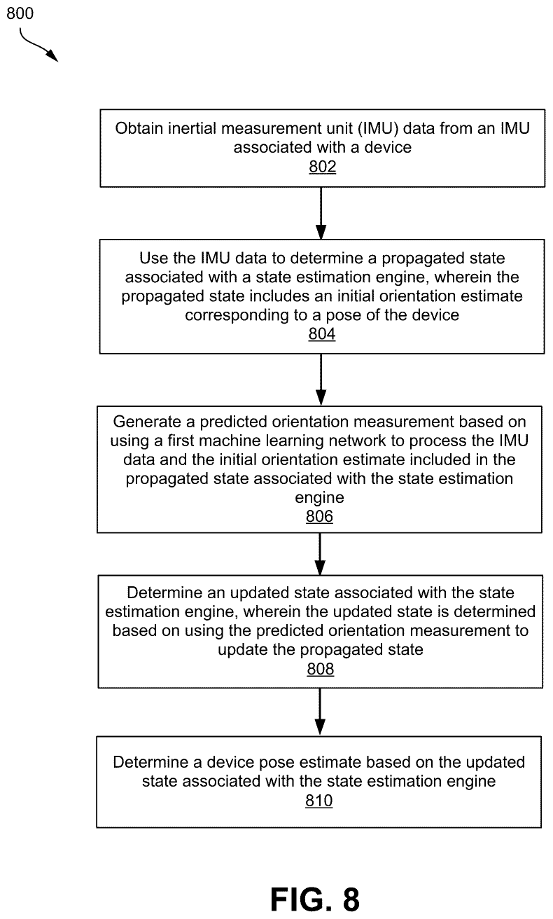

FIG. 8 is a flowchart diagram illustrating an example of a process 800 that can be used for predicting a pose (e.g., predicting pose information). Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

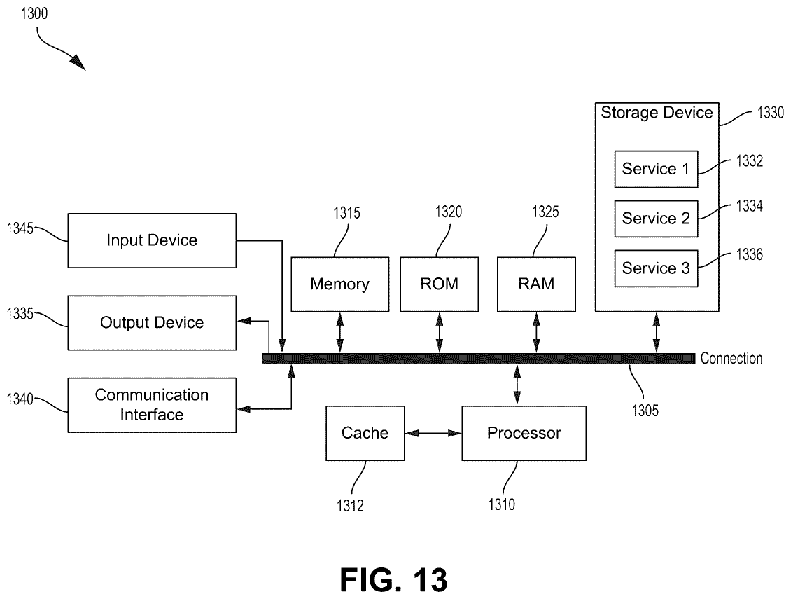

In some examples, the process 800 can be performed by a computing device or apparatus or a component or system (e.g., one or more chipsets, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 1310 of FIG. 13 or other processor(s)). In some examples, the process 800 can be performed by a machine learning network, including any of the machine learning networks and/or neural networks corresponding to FIGS. 1-7B. In some aspects, the process 800 can be performed by a UE, smartphone, mobile computing device, user computing device, etc. The process 800 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., processor 1310 of FIG. 13, and/or other processor(s)).

At block 802, the apparatus (or component thereof) can obtain inertial measurement unit (IMU) data from an IMU associated with a device. For example, the IMU data can be obtained from an IMU the same as or similar to the IMU 404 of FIG. 4A, the IMU 454 of FIG. 4B, the IMU 504 of FIG. 5, etc. In some cases, the IMU data includes acceleration information and angular velocity information associated with movement of the device with which the IMU is associated. In some cases, the IMU data can be obtained from an IMU buffer associated with the IMU. For example, the IMU buffer can be the same as or similar to the IMU buffer 508 of FIG. 5, etc. In some examples, the IMU data can be the same as or similar to the IMU data 306 obtained from the IMU 304 associated with the mobile device 302 of FIG. 3.

At block 804, the apparatus (or component thereof) can determine, using the IMU data, a propagated state associated with a state estimation engine, wherein the propagated state includes an initial orientation estimate corresponding to a pose of the device. In some aspects, the state estimation engine comprises an Extended Kalman Filter (EKF) or other type of linear quadratic estimation engine and/or nonlinear quadratic estimation engine.

For example, the propagated state can be the same as or similar to the updated state associated with the Kalman Filter Update 476 of FIG. 4B and/or the Kalman Filter Propagation 472 of FIG. 4B. In some examples, the propagated state associated with the EKF can be the same as or similar to the EKF state 545 associated with the EKF 540 of FIG. 5. In some cases, the initial orientation estimate corresponding to the pose of the device can be included in the device pose estimate 430 of FIG. 4A, the device pose estimate 480 of FIG. 4B, the device pose estimate and/or orientation included within the EKF state 545 of FIG. 5, etc.

In some cases, the propagated state associated with the EKF includes a propagated quaternion indicative of the initial orientation estimate. For example, the propagated quaternion can be the same as or similar to a propagated quaternion 614 of FIG. 6, 714a of FIG. 7A, 714b of FIG. 7B, etc.

At block 806, the apparatus (or component thereof) can generate a predicted orientation measurement based on using a first machine learning network to process the IMU data and the initial orientation estimate included in the propagated state associated with the state estimation engine (e.g., EKF).

For example, the first machine learning network can be a machine learning network included in the pose estimation engine 308 of FIG. 3, configured to generate the estimated pose information 330 based on processing the IMU data 306 of FIG. 3. In some cases, the first machine learning network can be the same as or similar to the ML model 410 of FIG. 4A and can be configured to generate the corresponding pose measurement estimate output of FIG. 4A. In some cases, the first machine learning network can be the same as or similar to the ML model 460 of FIG. 4B and can be configured to generate the corresponding pose measurement estimate output and uncertainties of FIG. 4B. In some examples, the first machine learning network can be the same as or similar to the pose estimation neural network 520 of FIG. 5, configured to generate a predicted orientation measurement included in the output (e.g., the refined estimates 525) of the pose estimation neural network 520.

In some cases, the first machine learning network can include the machine learning orientation estimation engine 610 of FIG. 6, and/or the orientation estimation engine 700a of FIG. 7A, and/or the orientation estimation engine 700b of FIG. 7B, etc. In some examples, the first machine learning network can be associated with or included in a machine learning system or machine learning architecture that also includes the velocity estimation engine 640 and/or the position estimation engine 670 of FIG. 6.

In some cases, the first machine learning network can be trained based at least in part on using a random self-supervision sign flip bit for orientation inputs. For example, the random self-supervision sign flip bit can be applied to one or more of the inputs 612 and/or 614 provided to the orientation estimation engine 610 of FIG. 6.

In some cases, generating the predicted orientation measurement using the first machine learning network includes processing the IMU data using an encoder of the first machine learning network, wherein the encoder generates an encoded representation of the IMU data. For example, the encoder of the first machine learning network can be the same as or similar to the orientation encoder 622 of FIG. 6. Generating the predicted orientation measurement using the first machine learning network can further include processing the initial orientation estimate and the encoded representation of the IMU data using a decoder of the first machine learning network, wherein the decoder generates an output indicative of the predicted orientation measurement. For example, the decoder can be the same as or similar to the orientation decoder 626 of FIG. 6. In some cases, the decoder output indicative of the predicted orientation measurement can be an output of the orientation decoder 626 indicative of the predicted orientation measurement 628 of FIG. 6.

In some examples, the encoder comprises a Transformer-based machine learning encoder architecture and the decoder comprises a Transformer-based machine learning decoder architecture. In some cases, the predicted orientation measurement comprises a predicted orientation change measurement or an absolute orientation prediction. In some examples, the predicted orientation measurement comprises a unit quaternion corresponding to a three-dimensional (3D) rotation operation.

In some cases, generating the predicted orientation measurement further includes using the first machine learning network to determine a predicted uncertainty (e.g., a predicted orientation measurement uncertainty) corresponding to the unit quaternion. For example, the predicted uncertainty (e.g., predicted orientation measurement uncertainty) can be the same as or similar to the output of the predicted uncertainty generated by the pose estimation neural network 520 of FIG. 5. In some examples, the predicted uncertainty can be the same as or similar to the uncertainty included in the orientation estimation engine 610 output prediction 628 of FIG. 6.

In some examples, generating the predicted orientation measurement comprises processing an intermediate decoder output representation of the first machine learning network using a normalization layer to generate the unit quaternion. For example, the intermediate decoder output representation can be the same as or similar to the orientation decoder 626 output representation of FIG. 6, provided as input to the linear layers and the normalization layer 627 of FIG. 6. The unit quaternion can be the quaternion included in the prediction output 628 of FIG. 6, downstream of the output of the normalization layer 627.

In some cases, the first machine learning network is trained using a random self-supervision sign flip bit for orientation inputs to modulate each quaternion input of a plurality of quaternion training inputs with a randomly selected positive sign value or negative sign value.

At block 808, the apparatus (or component thereof) can determine an updated state associated with the state estimation engine (e.g., EKF), wherein the updated state is determined based on using the predicted orientation measurement to update the propagated state. For example, determining the updated state associated with the state estimation engine (e.g., EKF) can comprise performing a filter update to the EKF using at least the predicted orientation measurement. In some cases, performing the filter update to the EKF can be the same as or similar to the filter update performed for the EKF 540 of FIG. 5 to update the EKF state 545 to a corresponding updated EKF state, based on the predicted orientation measurement output (e.g., the refined estimates 525) generated by the pose estimation neural network 520 of FIG. 5. In some cases, performing the filter update to the EKF can based on the KF update 476 of FIG. 4B, etc.

In some cases, the predicted orientation measurement generated using the first machine learning network comprises a predicted quaternion indicative of a refined orientation estimate corresponding to the pose of the device.

In some examples, the apparatus (or component thereof) can be further configured to determine linear acceleration information based on the IMU data, and to generate a refined velocity prediction based on using a second machine learning network to process the linear acceleration information, the predicted quaternion from the first machine learning network, and an initial velocity estimate included in the propagated state associated with the EKF.

For example, the linear acceleration information can be the same as or similar to the linear acceleration information 642 of FIG. 6. In some cases, the linear acceleration information can be determined by the second machine learning network, which may be the same as or similar to the velocity estimation engine 640 of FIG. 6. In some examples, the linear acceleration information can be the same as the linear acceleration information 642 determined based on the IMU data 641 of FIG. 6.

In some cases, the refined velocity prediction can be generated based on using the velocity estimation engine 640 of FIG. 6 to process the linear acceleration information 642 of FIG. 6. The velocity estimation engine 640 of FIG. 6 can further process the predicted quaternion from the first machine learning network (e.g., the unit quaternion of the prediction output 628 of the orientation estimation engine 610 of FIG. 6), and can further process the initial velocity estimate 644 of FIG. 6 to generate the refined velocity prediction 658 of FIG. 6.

In some cases, determining the updated state associated with the EKF is based on a filter update to the propagated state, the filter update based on at least the predicted quaternion from the first machine learning network and the refined velocity prediction generated using the second machine learning network.

In some examples, the apparatus (or component thereof) can be further configured to provide the linear acceleration information from the second machine learning network to a third machine learning network. For example, the linear acceleration information 642 can be provided from a second machine learning network the same as or similar to the velocity estimation engine 640 of FIG. 6, to a third machine learning network the same as or similar to the position estimation engine 670 of FIG. 6. In some cases, a refined position prediction can be generated based on using the third machine learning network to process the linear acceleration information, the refined velocity prediction, and an initial position estimate included in the propagated state associated with the EKF. For example, the refined position prediction can be the same as or similar to the refined position prediction output 688 generated by the position estimation engine 670 of FIG. 6. In some examples, the filter update to the propagated state is further based on the refined position prediction generated using the third machine learning network.

At block 810, the apparatus (or component thereof) can determine a device pose estimate based on the updated state associated with the state estimation engine (e.g., EKF). For example, determining the device pose estimate based on the updated state associated with the EKF can comprise fusing the propagated quaternion indicative of the initial orientation estimate with a unit quaternion predicted using the first machine learning network, wherein the unit quaternion corresponds to the predicted orientation measurement. In some cases, the first machine learning network comprises a sequence-to-sequence regression transformer machine learning architecture including a Transformer-based encoder and a Transformer-based decoder. In some cases, the IMU data is obtained from an IMU buffer and includes respective acceleration information and respective angular velocity information obtained using the IMU for a plurality of time steps within a configured input window. In some examples, determining the propagated state associated with the EKF comprises performing state propagation to predict the propagated state for a future time step. In some cases, the state propagation is based on the IMU data obtained for the plurality of time steps within the configured input window, and is further based on EKF history state information corresponding to an updated state determined for the EKF in each respective time step of the plurality of time steps within the configured input window.

In some examples, the processes described herein (e.g., the process 800 and/or any other process described herein) may be performed by a computing device or apparatus. In some aspects, the process 800 and/or other technique or process described herein can be performed by a computing system having an architecture according to any of FIGS. 1-7B. In another example, the process 800 and/or other technique or process described herein can be performed by the computing system 1300 shown in FIG. 13. In some examples, the computing device can include a mobile device (e.g., a mobile phone, a tablet computing device, etc.), a wearable device, an extended reality device (e.g., a virtual reality (VR) device, an augmented reality (AR) device, or a mixed reality (MR) device), a personal computer, a laptop computer, a video server, a television, a vehicle (or a computing device of a vehicle), robotic device, and/or any other computing device with the resource capabilities to perform the processes described herein.

In some cases, the computing device or apparatus may include various components, such as one or more input devices, one or more output devices, one or more processors, one or more microprocessors, one or more microcomputers, one or more transmitters, receivers or combined transmitter-receivers (e.g., referred to as transceivers), one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), and/or other suitable electronic circuits), and/or can include and/or be implemented using computer software, firmware, or any combination thereof, to perform the various operations described herein.

The processes described herein may be illustrated or described as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted previously, neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

FIG. 9 is an illustrative example of a deep learning neural network 900. An input layer 920 includes input data. In some cases, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In some aspects, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [00 1000000 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. An example of a CNN is described below with respect to FIG. 10. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

FIG. 10 is an illustrative example of a convolutional neural network 1000 (CNN 1000). The input layer 1020 of the CNN 1000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In some aspects, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a.

For example, a filter can be moved by a step amount to the next receptive field. The step amount can be set to 1 or other suitable amount. For example, if the step amount is set to 1, the filter will be moved to the right by 1 pixel at each convolutional iteration.

Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. An example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is an example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling layer 1022b (which should represent the activation maps of high-level features) and determines the features that most correlate to a particular class. For example, the fully connected layer 1022c layer can determine the high-level features that most strongly correlate to a particular class, and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some cases, if a 10-dimensional output vector represents ten different classes of objects is [0 0 0.05 0.8 00.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

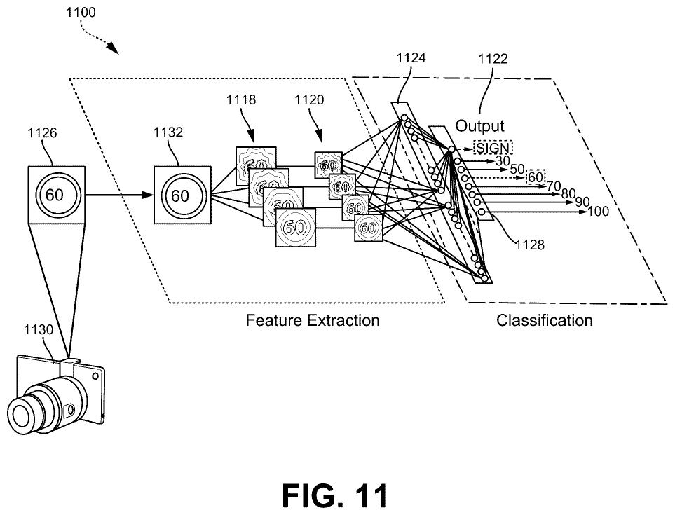

One type of convolutional neural network is a deep convolutional network (DCN). FIG. 11 illustrates a detailed example of a DCN 1100 designed to recognize visual features from an image 1126 input from an image capturing device 1130, such as a car-mounted camera. The DCN 1100 of the current example may be trained to identify traffic signs and a number provided on the traffic sign. Of course, the DCN 1100 may be trained for other tasks, such as identifying lane markings or identifying traffic lights.

The DCN 1100 may be trained with supervised learning. During training, the DCN 1100 may be presented with an image, such as the image 1126 of a speed limit sign, and a forward pass may then be computed to produce an output 1122. The DCN 1100 may include a feature extraction section and a classification section. Upon receiving the image 1126, a convolutional layer 1132 may apply convolutional kernels (not shown) to the image 1126 to generate a first set of feature maps 1118. As an example, the convolutional kernel for the convolutional layer 1132 may be a 5×5 kernel that generates 28×28 feature maps. In the present example, because four different feature maps are generated in the first set of feature maps 1118, four different convolutional kernels were applied to the image 1126 at the convolutional layer 1132. The convolutional kernels may also be referred to as filters or convolutional filters.

The first set of feature maps 1118 may be subsampled by a max pooling layer (not shown) to generate a second set of feature maps 1120. The max pooling layer reduces the size of the first set of feature maps 1118. That is, a size of the second set of feature maps 1120, such as 14×14, is less than the size of the first set of feature maps 1118, such as 28×28. The reduced size provides similar information to a subsequent layer while reducing memory consumption. The second set of feature maps 1120 may be further convolved via one or more subsequent convolutional layers (not shown) to generate one or more subsequent sets of feature maps (not shown).

In the example of FIG. 11, the second set of feature maps 1120 is convolved to generate a first feature vector 1124. Furthermore, the first feature vector 1124 is further convolved to generate a second feature vector 1128. Each feature of the second feature vector 1128 may include a number that corresponds to a possible feature of the image 1126, such as “sign,” “60,” and “100.” A softmax function (not shown) may convert the numbers in the second feature vector 1128 to a probability. As such, an output 1122 of the DCN 1100 is a probability of the image 1126 including one or more features.

In the present example, the probabilities in the output 1122 for “sign” and “60” are higher than the probabilities of the others of the output 1122, such as “30,” “40,” “50,” “70,” “80,” “90,” and “100”. Before training, the output 1122 produced by the DCN 1100 is likely to be incorrect. Thus, an error may be calculated between the output 1122 and a target output. The target output is the ground truth of the image 1126 (e.g., “sign” and “60”). The weights of the DCN 1100 may then be adjusted so the output 1122 of the DCN 1100 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 1122 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information associated with the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 1120) receiving input from a range of neurons in the previous layer (e.g., feature maps 1118) and from each of the multiple channels. The values in the feature map may be further processed with a non-linearity, such as a rectification, max (0,x). Values from adjacent neurons may be further pooled, which corresponds to down sampling, and may provide additional local invariance and dimensionality reduction.

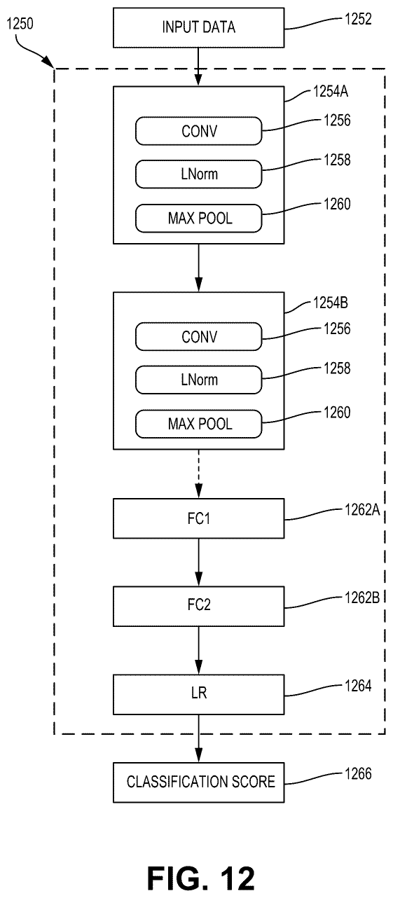

FIG. 12 is a block diagram illustrating an example of a deep convolutional network (DCN) 1250. The deep convolutional network 1250 may include multiple different types of layers based on connectivity and weight sharing. As shown in FIG. 12, the deep convolutional network 1250 includes the convolution blocks 1254A, 1254B. Each of the convolution blocks 1254A, 1254B may be configured with a convolution layer (CONV) 1256, a normalization layer (LNorm) 1258, and a max pooling layer (MAX POOL) 1260.

The convolution layers 1256 may include one or more convolutional filters, which may be applied to the input data 1252 to generate a feature map. Although only two convolution blocks 1254A, 1254B are shown, the present disclosure is not so limiting, and instead, any number of convolution blocks (e.g., blocks 1254A, 1254B) may be included in the deep convolutional network 1250 according to design preference. The normalization layer 1258 may normalize the output of the convolution filters. For example, the normalization layer 1258 may provide whitening or lateral inhibition. The max pooling layer 1260 may provide down sampling aggregation over space for local invariance and dimensionality reduction.

The parallel filter banks, for example, of a deep convolutional network may be loaded on a CPU or GPU of an SOC (e.g., such as the CPU 102 or GPU 104 of the SOC 100 of FIG. 1, etc.) to achieve high performance and low power consumption. In alternative aspects, the parallel filter banks may be loaded on the DSP 106 or an ISP 116 of the SOC 100 of FIG. 1. In addition, the deep convolutional network 1250 may access other processing blocks that may be present on the SOC 100 of FIG. 1, such as sensor processor 114 and storage 120, etc.

The deep convolutional network 1250 may also include one or more fully connected layers, such as layer 1262A (labeled “FC1”) and layer 1262B (labeled “FC2”). The deep convolutional network 1250 may further include a logistic regression (LR) layer 1264. Between each layer 1256, 1258, 1260, 1262A, 1262B, 1264 of the deep convolutional network 1250 are weights (not shown) that are to be updated. The output of each of the layers (e.g., 1256, 1258, 1260, 1262A, 1262B, 1264) may serve as an input of a succeeding one of the layers (e.g., 1256, 1258, 1260, 1262A, 1262B, 1264) in the deep convolutional network 1250 to learn hierarchical feature representations from input data 1252 (e.g., images, audio, video, sensor data and/or other input data) supplied at the first of the convolution blocks 1254A. The output of the deep convolutional network 1250 is a classification score 1266 for the input data 1252. The classification score 1266 may be a set of probabilities, where each probability is the probability of the input data including a feature from a set of features.

FIG. 13 illustrates an example computing device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1300 are shown in electrical communication with each other using connection 1305, such as a bus. The example computing device architecture 1300 includes a processing unit (CPU or processor) 1310 and computing device connection 1305 that couples various computing device components including computing device memory 1315, such as read only memory (ROM) 1320 and random access memory (RAM) 1325, to processor 1310.

Computing device architecture 1300 can include a cache of high-speed memory connected directly with, in close proximity to, or integrated as part of processor 1310. Computing device architecture 1300 can copy data from memory 1315 and/or the storage device 1330 to cache 1312 for quick access by processor 1310. In this way, the cache can provide a performance boost that avoids processor 1310 delays while waiting for data. These and other modules can control or be configured to control processor 1310 to perform various actions. Other computing device memory 1315 may be available for use as well. Memory 1315 can include multiple different types of memory with different performance characteristics. Processor 1310 can include any general purpose processor and a hardware or software service, such as service 1 1332, service 2 1334, and service 3 1336 stored in storage device 1330, configured to control processor 1310 as well as a special-purpose processor where software instructions are incorporated into the processor design. Processor 1310 may be a self-contained system, containing multiple cores or processors, a bus, memory controller, cache, etc. A multi-core processor may be symmetric or asymmetric.

To enable user interaction with the computing device architecture 1300, input device 1345 can represent any number of input mechanisms, such as a microphone for speech, a touch-sensitive screen for gesture or graphical input, keyboard, mouse, motion input, speech and so forth. Output device 1335 can also be one or more of a number of output mechanisms known to those of skill in the art, such as a display, projector, television, speaker device, etc. In some instances, multimodal computing devices can enable a user to provide multiple types of input to communicate with computing device architecture 1300. Communication interface 1340 can generally govern and manage the user input and computing device output. There is no restriction on operating on any particular hardware arrangement and therefore the basic features here may easily be substituted for improved hardware or firmware arrangements as they are developed.

Storage device 1330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1325, read only memory (ROM) 1320, and hybrids thereof. Storage device 1330 can include services 1332, 1334, 1336 for controlling processor 1310. Other hardware or software modules are contemplated. Storage device 1330 can be connected to the computing device connection 1305. In some aspects, a hardware module that performs a particular function can include the software component stored in a computer-readable medium in connection with the necessary hardware components, such as processor 1310, connection 1305, output device 1335, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Disclosure Include:

Aspect 1. A method comprising: obtaining inertial measurement unit (IMU) data from an IMU associated with a device; determining, using the IMU data, a propagated state associated with a state estimation engine, wherein the propagated state includes an initial orientation estimate corresponding to a pose of the device; generating a predicted orientation measurement based on using a first machine learning network to process the IMU data and the initial orientation estimate included in the propagated state associated with the state estimation engine; determining an updated state associated with the state estimation engine, wherein the updated state is determined based on using the predicted orientation measurement to update the propagated state; and determining a device pose estimate based on the updated state associated with the state estimation engine.
Aspect 2. The method of Aspect 1, wherein the first machine learning network is trained based at least in part on using a random self-supervision sign flip bit for orientation inputs.
Aspect 3. The method of any of Aspects 1 to 2, wherein generating the predicted orientation measurement using the first machine learning network includes: processing the IMU data using an encoder of the first machine learning network, wherein the encoder generates an encoded representation of the IMU data; and processing the initial orientation estimate and the encoded representation of the IMU data using a decoder of the first machine learning network, wherein the decoder generates an output indicative of the predicted orientation measurement.
Aspect 4. The method of Aspect 3, wherein the encoder comprises a Transformer-based machine learning encoder architecture and the decoder comprises a Transformer-based machine learning decoder architecture.
Aspect 5. The method of any of Aspects 1 to 4, wherein the predicted orientation measurement comprises a predicted orientation change measurement or an absolute orientation prediction.
Aspect 6. The method of any of Aspects 1 to 5, wherein the predicted orientation measurement comprises a unit quaternion corresponding to a three-dimensional (3D) rotation operation.
Aspect 7. The method of Aspect 6, wherein generating the predicted orientation measurement further includes using the first machine learning network to determine a predicted orientation measurement uncertainty corresponding to the unit quaternion.
Aspect 8. The method of any of Aspects 6 to 7, wherein generating the predicted orientation measurement comprises processing an intermediate decoder output representation of the first machine learning network using a normalization layer to generate the unit quaternion.
Aspect 9. The method of any of Aspects 6 to 8, wherein the first machine learning network is trained using a random self-supervision sign flip bit for orientation inputs to modulate each quaternion input of a plurality of quaternion training inputs with a randomly selected positive sign value or negative sign value.
Aspect 10. The method of any of Aspects 1 to 9, wherein: the IMU data includes acceleration information and angular velocity information; and the propagated state associated with the state estimation engine includes a propagated quaternion indicative of the initial orientation estimate.
Aspect 11. The method of Aspect 10, wherein determining the device pose estimate based on the updated state associated with the state estimation engine comprises: fusing the propagated quaternion indicative of the initial orientation estimate with a unit quaternion predicted using the first machine learning network, wherein the unit quaternion corresponds to the predicted orientation measurement.
Aspect 12. The method of any of Aspects 1 to 11, wherein: determining the updated state associated with the state estimation engine comprises performing a filter update to the state estimation engine using at least the predicted orientation measurement; and the predicted orientation measurement generated using the first machine learning network includes at least one of a predicted quaternion indicative of a refined orientation estimate corresponding to the pose of the device or a predicted orientation measurement uncertainty associated with the first machine learning network.
Aspect 13. The method of Aspect 12, further comprising: determining linear acceleration information based on the IMU data; and generating a refined velocity prediction and a corresponding velocity prediction uncertainty, based on using a second machine learning network to process the linear acceleration information, the predicted quaternion from the first machine learning network, and an initial velocity estimate included in the propagated state associated with the state estimation engine.
Aspect 14. The method of Aspect 13, wherein determining the updated state associated with the state estimation engine is based on a filter update to the propagated state, the filter update based on at least the predicted quaternion and predicted orientation measurement uncertainty from the first machine learning network and the refined velocity prediction and corresponding velocity prediction uncertainty generated using the second machine learning network.
Aspect 15. The method of any of Aspects 13 to 14, further comprising: providing the linear acceleration information from the second machine learning network to a third machine learning network; and generating a refined position prediction and a corresponding position prediction uncertainty, based on using the third machine learning network to process the linear acceleration information, the refined velocity prediction, and an initial position estimate included in the propagated state associated with the state estimation engine.
Aspect 16. The method of Aspect 15, wherein the filter update to the propagated state is further based on the refined position prediction and the corresponding position prediction uncertainty generated using the third machine learning network.
Aspect 17. The method of any of Aspects 1 to 16, wherein the first machine learning network comprises a sequence-to-sequence regression transformer machine learning architecture including one or more Transformer-based encoders and one or more Transformer-based decoders.
Aspect 18. The method of Aspect 17, wherein: the IMU data is obtained from an IMU buffer and includes respective acceleration information and respective angular velocity information obtained using the IMU for a plurality of time steps within a configured input window; and determining the propagated state associated with the state estimation engine comprises performing state propagation to predict the propagated state for a future time step.
Aspect 19. The method of Aspect 18, wherein the state estimation engine comprises an Extended Kalman Filter (EKF), and wherein the state propagation is based on: the IMU data obtained for the plurality of time steps within the configured input window; and EKF history state information corresponding to an updated state determined for the EKF in each respective time step of the plurality of time steps within the configured input window.
Aspect 20. The method of any of Aspects 1 to 19, wherein the state estimation engine comprises an Extended Kalman Filter (EKF).
Aspect 21. An apparatus comprising: at least one memory; and at least one processor coupled to the at least one memory and configured to: obtain inertial measurement unit (IMU) data from an IMU associated with a device; determine, using the IMU data, a propagated state associated with a state estimation engine, wherein the propagated state includes an initial orientation estimate corresponding to a pose of the device; generate a predicted orientation measurement based on using a first machine learning network to process the IMU data and the initial orientation estimate included in the propagated state associated with the state estimation engine; determine an updated state associated with the state estimation engine, wherein the updated state is determined based on using the predicted orientation measurement to update the propagated state; and determine a device pose estimate based on the updated state associated with the state estimation engine.
Aspect 22. The apparatus of Aspect 21, wherein the first machine learning network is trained based at least in part on using a random self-supervision sign flip bit for orientation inputs.
Aspect 23. The apparatus of any of Aspects 21 to 22, wherein, to generate the predicted orientation measurement using the first machine learning network, the at least one processor is configured to: process the IMU data using an encoder of the first machine learning network, wherein the encoder generates an encoded representation of the IMU data; and process the initial orientation estimate and the encoded representation of the IMU data using a decoder of the first machine learning network, wherein the decoder generates an output indicative of the predicted orientation measurement.
Aspect 24. The apparatus of Aspect 23, wherein the encoder comprises a Transformer-based machine learning encoder architecture and the decoder comprises a Transformer-based machine learning decoder architecture.
Aspect 25. The apparatus of any of Aspects 21 to 24, wherein the state estimation engine comprises an Extended Kalman Filter (EKF).
Aspect 26. The apparatus of any of Aspects 21 to 25, wherein the predicted orientation measurement comprises a predicted orientation change measurement or an absolute orientation prediction.
Aspect 27. The apparatus of any of Aspects 21 to 26, wherein the predicted orientation measurement comprises a unit quaternion corresponding to a three-dimensional (3D) rotation operation.
Aspect 28. The apparatus of Aspect 27, wherein, to generate the predicted orientation measurement, the at least one processor is configured to use the first machine learning network to determine a predicted orientation measurement uncertainty corresponding to the unit quaternion.
Aspect 29. The apparatus of any of Aspects 27 to 29, wherein, to generate the predicted orientation measurement, the at least one processor is configured to process an intermediate decoder output representation of the first machine learning network using a normalization layer to generate the unit quaternion.
Aspect 30. The apparatus of any of Aspects 27 to 29, wherein the first machine learning network is trained using a random self-supervision sign flip bit for orientation inputs to modulate each quaternion input of a plurality of quaternion training inputs with a randomly selected positive sign value or negative sign value.
Aspect 31. The apparatus of any of Aspects 21 to 30, wherein: the IMU data includes acceleration information and angular velocity information; and the propagated state associated with the state estimation engine includes a propagated quaternion indicative of the initial orientation estimate.
Aspect 32. The apparatus of Aspect 31, wherein, to determine the device pose estimate based on the updated state associated with the state estimation engine, the at least one processor is configured to: fuse the propagated quaternion indicative of the initial orientation estimate with a unit quaternion predicted using the first machine learning network, wherein the unit quaternion corresponds to the predicted orientation measurement.
Aspect 33. The apparatus of any of Aspects 21 to 32, wherein: to determine the updated state associated with the state estimation engine, the at least one processor is configured to perform a filter update to the state estimation engine using at least the predicted orientation measurement; and the predicted orientation measurement generated using the first machine learning network includes at least one of a predicted quaternion indicative of a refined orientation estimate corresponding to the pose of the device or a predicted orientation measurement uncertainty associated with the first machine learning network.
Aspect 34. The apparatus of Aspect 33, wherein the at least one processor is further configured to: determine linear acceleration information based on the IMU data; and generate a refined velocity prediction and a corresponding velocity prediction uncertainty, based on using a second machine learning network to process the linear acceleration information, the predicted quaternion from the first machine learning network, and an initial velocity estimate included in the propagated state associated with the state estimation engine.
Aspect 35. The apparatus of Aspect 34, wherein the at least one processor is configured to determine the updated state associated with the state estimation engine based on a filter update to the propagated state, the filter update based on at least the predicted quaternion and predicted orientation measurement uncertainty from the first machine learning network and the refined velocity prediction and corresponding velocity prediction uncertainty generated using the second machine learning network.
Aspect 36. The apparatus of any of Aspects 34 to 35, wherein the at least one processor is further configured to: provide the linear acceleration information from the second machine learning network to a third machine learning network; and generate a refined position prediction and a corresponding position prediction uncertainty, based on using the third machine learning network to process the linear acceleration information, the refined velocity prediction, and an initial position estimate included in the propagated state associated with the state estimation engine.
Aspect 37. The apparatus of Aspect 36, wherein the filter update to the propagated state is further based on the refined position prediction and the corresponding position prediction uncertainty generated using the third machine learning network.
Aspect 38. The apparatus of any of Aspects 21 to 37, wherein the first machine learning network comprises a sequence-to-sequence regression transformer machine learning architecture including one or more Transformer-based encoders and one or more Transformer-based decoders.
Aspect 39. The apparatus of Aspect 38, wherein: the at least one processor is configured to obtain the IMU data from an IMU buffer, the IMU data including respective acceleration information and respective angular velocity information obtained using the IMU for a plurality of time steps within a configured input window; and, to determine the propagated state associated with the state estimation engine, the at least one processor is configured to perform state propagation to predict the propagated state for a future time step.
Aspect 40. The apparatus of Aspect 39, wherein the state estimation engine comprises an Extended Kalman Filter (EKF), and wherein the state propagation is based on: the IMU data obtained for the plurality of time steps within the configured input window; and EKF history state information corresponding to an updated state determined for the EKF in each respective time step of the plurality of time steps within the configured input window.
Aspect 41. A non-transitory computer-readable storage medium comprising instructions stored thereon which, when executed by at least one processor, causes the at least one processor to perform operations according to any of Aspects 1 to 20.
Aspect 42. A non-transitory computer-readable storage medium comprising instructions stored thereon which, when executed by at least one processor, causes the at least one processor to perform operations according to any of Aspects 21 to 40.
Aspect 43. An apparatus comprising one or more means for performing operations according to any of Aspects 1 to 20.
Aspect 44. An apparatus comprising one or more means for performing operations according to any of Aspects 21 to 40.

What is claimed is:

1. An apparatus comprising:
at least one memory; and
at least one processor coupled to the at least one memory and configured to:
obtain inertial measurement unit (IMU) data from an IMU associated with a device;
determine, using the IMU data, a propagated state associated with a state estimation engine, wherein the propagated state includes an initial orientation estimate corresponding to a pose of the device;
generate a predicted orientation measurement based on using a first machine learning network to process the IMU data and the initial orientation estimate included in the propagated state associated with the state estimation engine;
determine an updated state associated with the state estimation engine, wherein the updated state is determined based on using the predicted orientation measurement to update the propagated state; and
determine a device pose estimate based on the updated state associated with the state estimation engine.

2. The apparatus of claim 1, wherein the first machine learning network is trained based at least in part on using a random self-supervision sign flip bit for orientation inputs.

3. The apparatus of claim 1, wherein, to generate the predicted orientation measurement using the first machine learning network, the at least one processor is configured to:
process the IMU data using an encoder of the first machine learning network, wherein the encoder generates an encoded representation of the IMU data; and
process the initial orientation estimate and the encoded representation of the IMU data using a decoder of the first machine learning network, wherein the decoder generates an output indicative of the predicted orientation measurement.

4. The apparatus of claim 1, wherein the state estimation engine comprises an Extended Kalman Filter (EKF).

5. The apparatus of claim 1, wherein the predicted orientation measurement comprises a predicted orientation change measurement or an absolute orientation prediction.

6. The apparatus of claim 1, wherein the predicted orientation measurement comprises a unit quaternion corresponding to a three-dimensional (3D) rotation operation.

7. The apparatus of claim 6, wherein, to generate the predicted orientation measurement, the at least one processor is configured to use the first machine learning network to determine a predicted orientation measurement uncertainty corresponding to the unit quaternion.

8. The apparatus of claim 6, wherein, to generate the predicted orientation measurement, the at least one processor is configured to process an intermediate decoder output representation of the first machine learning network using a normalization layer to generate the unit quaternion.

9. The apparatus of claim 6, wherein the first machine learning network is trained using a random self-supervision sign flip bit for orientation inputs to modulate each quaternion input of a plurality of quaternion training inputs with a randomly selected positive sign value or negative sign value.

10. The apparatus of claim 1, wherein:
the IMU data includes acceleration information and angular velocity information; and
the propagated state associated with the state estimation engine includes a propagated quaternion indicative of the initial orientation estimate.

11. The apparatus of claim 10, wherein, to determine the device pose estimate based on the updated state associated with the state estimation engine, the at least one processor is configured to:
fuse the propagated quaternion indicative of the initial orientation estimate with a unit quaternion predicted using the first machine learning network, wherein the unit quaternion corresponds to the predicted orientation measurement.

12. The apparatus of claim 1, wherein, to determine the updated state associated with the state estimation engine, the at least one processor is configured to perform a filter update to the state estimation engine using at least the predicted orientation measurement, and wherein the predicted orientation measurement generated using the first machine learning network includes at least one of a predicted quaternion indicative of a refined orientation estimate corresponding to the pose of the device or a predicted orientation measurement uncertainty associated with the first machine learning network.

13. The apparatus of claim 12, wherein the at least one processor is configured to:
determine linear acceleration information based on the IMU data; and
generate a refined velocity prediction and a corresponding velocity prediction uncertainty, based on using a second machine learning network to process the linear acceleration information, the predicted quaternion from the first machine learning network, and an initial velocity estimate included in the propagated state associated with the state estimation engine.

14. The apparatus of claim 13, wherein the at least one processor is configured to determine the updated state associated with the state estimation engine based on a filter update to the propagated state, the filter update based on at least the predicted quaternion and predicted orientation measurement uncertainty from the first machine learning network and the refined velocity prediction and corresponding velocity prediction uncertainty generated using the second machine learning network.

15. The apparatus of claim 13, wherein the at least one processor is configured to:
provide the linear acceleration information from the second machine learning network to a third machine learning network; and
generate a refined position prediction and a corresponding position prediction uncertainty, based on using the third machine learning network to process the linear acceleration information, the refined velocity prediction, and an initial position estimate included in the propagated state associated with the state estimation engine.

16. The apparatus of claim 15, wherein the filter update to the propagated state is further based on the refined position prediction and the corresponding position prediction uncertainty generated using the third machine learning network.

17. The apparatus of claim 1, wherein the first machine learning network comprises a sequence-to-sequence regression transformer machine learning architecture including one or more Transformer-based encoders and one or more Transformer-based decoders.

18. The apparatus of claim 17, wherein:
the at least one processor is configured to obtain the IMU data from an IMU buffer, the IMU data including respective acceleration information and respective angular velocity information obtained using the IMU for a plurality of time steps within a configured input window; and
to determine the propagated state associated with the state estimation engine, the at least one processor is configured to perform state propagation to predict the propagated state for a future time step.

19. The apparatus of claim 18, wherein the state estimation engine comprises an Extended Kalman Filter (EKF), and wherein the state propagation is based on:
the IMU data obtained for the plurality of time steps within the configured input window; and
EKF history state information corresponding to an updated state determined for the EKF in each respective time step of the plurality of time steps within the configured input window.

20. A method comprising:
obtaining inertial measurement unit (IMU) data from an IMU associated with a device;
determining, using the IMU data, a propagated state associated with a state estimation engine, wherein the propagated state includes an initial orientation estimate corresponding to a pose of the device;
generating a predicted orientation measurement based on using a first machine learning network to process the IMU data and the initial orientation estimate included in the propagated state associated with the state estimation engine;
determining an updated state associated with the state estimation engine, wherein the updated state is determined based on using the predicted orientation measurement to update the propagated state; and
determining a device pose estimate based on the updated state associated with the state estimation engine.
